(19) United States
(12) Patent Application Publication
(10) Pub. No.: US 2014/0369668 A1
(43) Pub. Date: Dec. 18, 2014

(54) METHOD, APPARATUS, AND STORAGE MEDIUM

(71) Applicant: KABUSHIKI KAISHA TOSHIBA, Tokyo (JP)

(72) Inventor: Atsushi Onoda, Ome-shi (JP)

(73) Assignee: KABUSHIKI KAISHA TOSHIBA, Tokyo (JP)

(21) Appl. No.: 14/137,883

(22) Filed: Dec. 20, 2013

(30) Foreign Application Priority Data
Jun. 14, 2013 (JP) 2013-125399

(51) Int. Cl. H04N 9/79

(52) U.S. Cl. CPC H04N 9/79
USPC 386/248

(57) ABSTRACT

According to one embodiment, an information processing method includes transmitting, receiving, and prohibiting. The transmitting is configured to transmit to a first apparatus, first scene information regarding a first scene of a plurality of scenes included in a first content. The receiving is configured to receive first information indicating that the first scene is not stored in the first apparatus. The prohibiting is configured to prohibit deletion of the first scene based on the first information.

### CROSS-REFERENCE TO RELATED APPLICATIONS

This application is based upon and claims the benefit of priority from Japanese Patent Application No. 2013-125399, filed Jun. 14, 2013; the entire contents of which are incorporated herein by reference.

### FIELD

Embodiments described herein relate generally to an information processing method, an electronic apparatus, and an computer-readable storage medium.

### BACKGROUND

In recent years, the functionality of digital televisions has become more sophisticated. For example, an enhanced digital television has a scene reproduction function in addition to its basic function. The basic function is a function of receiving, reproducing, and recording broadcast content. The scene reproduction function is a function of extracting a designated scene from a plurality of scenes included in recorded contents and reproducing the extracted scene.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating an example of a menu screen displayed on a screen of a display of a television apparatus of an embodiment.

FIG. 2 is a view illustrating another example of the menu screen displayed on a screen of the display of the television apparatus of the embodiment.

FIG. 3 is a view illustrating yet another example of the menu screen displayed on a screen of the display of the television apparatus of the embodiment.

FIG. 4 is a view illustrating still yet another example of the menu screen displayed on a screen of the display of the television apparatus of the embodiment.

FIG. 5 is a view illustrating an example of a state where an electronic apparatus of the embodiment is incorporated in a digital television receiver.

FIG. 6 is a block diagram illustrating a characteristic configuration example of the cloud application module 231 of FIG. 5.

FIG. 7 is a view illustrating a relationship between a television apparatus 300 and a time cloud service server 411 when a scene information function is used in the embodiment.

FIG. 8 is a view illustrating a relationship between the television apparatus 300 and time cloud service server 411 when the scene information function is used in the embodiment.

FIG. 9 is a view illustrating a relationship between the television apparatus 300 and time cloud service server 411 when the scene information function is used in the embodiment.

FIG. 10 is a view illustrating an example of servers included in a time cloud service server 411 in the embodiment.

FIG. 11 is a view illustrating an example of elements of a metadata server of FIG. 9 in the embodiment.

FIG. 12 is a view illustrating various configuration examples of the electronic apparatus and digital television functional module in the embodiment.

FIG. 13A is a view illustrating an example in which a monthly calendar is displayed in the television apparatus of the embodiment.

FIG. 13B is a view illustrating an example in which an event list which is additional information of the calendar is displayed in the television apparatus of the embodiment.

FIG. 13C is a view illustrating an example in which an event of FIG. 13B is displayed more in detail in the television apparatus of the embodiment.

FIG. 14A is a view illustrating an example in which a user Bob logs into the television apparatus of the embodiment and “Home” of the time cloud service is displayed.

FIG. 14B is a view illustrating an example in which a month grid of the calendar is displayed in the television apparatus of the embodiment.

FIG. 14C is a view illustrating an example in which the event list is displayed in the television apparatus of the embodiment.

FIG. 14D is a view illustrating an example in which details of the recording reservation are displayed in the television apparatus of the embodiment.

FIG. 15A is a view illustrating a first example in which the event list is scrolled in the television apparatus of the embodiment.

FIG. 15B is a view illustrating a second example in which the event list is scrolled in the television apparatus of the embodiment.

FIG. 15C is a view illustrating a third example in which the event list is scrolled in the television apparatus of the embodiment.

FIG. 15D is a view illustrating a fourth example in which the event list is scrolled in the television apparatus of the embodiment.

FIG. 15E is a view illustrating a fifth example in which the event list is scrolled in the television apparatus of the embodiment.

FIG. 15F is a view illustrating a sixth example in which the event list is scrolled in the television apparatus of the embodiment.

FIG. 16A is a view illustrating a display example when a day in which there is no event is selected from the monthly calendar in the television apparatus of the embodiment.

FIG. 16B is a view illustrating an example of a display image obtained by pressing a return button in a display state of an image of FIG. 16A.

FIG. 17A is a view illustrating an example of a transition state of an image of a monthly calendar in the television apparatus of the embodiment.

FIG. 17B is a view illustrating an example of a transition state of an image of a monthly calendar in the television apparatus of the embodiment.

FIG. 18A is a view illustrating an example of a transition state of an image of a monthly calendar in the television apparatus of the embodiment.

FIG. 18B is a view illustrating an example of a transition state of an image of a monthly calendar in the television apparatus of the embodiment.

FIG. 19A is a view illustrating an example of a transition state of an image of a monthly calendar in the television apparatus of the embodiment.

FIG. 19B is a view illustrating an example of a transition state of an image of a monthly calendar in the television apparatus of the embodiment.

FIG. 20A is a table listing an example of an icon to be displayed on the calendar in the television apparatus of the embodiment.

FIG. 20B is a table listing an example of an icon to be displayed on the calendar in the television apparatus of the embodiment.

FIG. 21 is a view illustrating an example of an image to be displayed when recording reservation information of one user are imported in the calendar of another user in the television apparatus of the embodiment.

FIG. 22 is a view illustrating another example of an image to be displayed when recording reservation information of one user are imported in the calendar of another user in the television apparatus of the embodiment.

FIG. 23 is a view illustrating an example of an image to be displayed when viewing reservation is canceled in the television apparatus of the embodiment.

FIG. 24 is a view illustrating an example of an image to be displayed when the viewing reservation or recording reservation is imported to user's calendar in the television apparatus of the embodiment.

FIG. 25 is a view illustrating a calendar information processing block in the television apparatus of the embodiment.

FIG. 26 is a view illustrating an example of an image to be displayed when an event filtering function is executed in the television apparatus of the embodiment.

FIG. 27 is a view illustrating an example of a setting image for asking a friend for SynchroViewing in the television apparatus of the embodiment.

FIG. 28 is a view illustrating an example of a setting image for asking a friend for SynchroViewing in the television apparatus of the embodiment.

FIG. 29 is a view illustrating an example of a monthly calendar image displayed on a tablet screen in a system of the embodiment.

FIG. 30 is a view illustrating an example of a weekly calendar image displayed on the tablet screen in the system of the embodiment.

FIG. 31 is a view illustrating an example of a daily calendar image displayed on the tablet screen in the system of the embodiment.

FIG. 32 is a view illustrating another example in which details of the event which is additional information of the calendar is displayed in the system of the embodiment.

FIG. 33 is a view illustrating a schematic configuration of the television apparatus of the embodiment.

FIG. 34 is a flowchart illustrating an example of scene recommendation processing (transmission processing) to be performed in the television apparatus of the embodiment.

FIG. 35 is a flowchart illustrating an example of the scene recommendation processing (reception processing) to be performed in the television apparatus of the embodiment.

### DETAILED DESCRIPTION

Various embodiments will be described hereinafter with reference to the accompanying drawings.

In general, according to one embodiment, an information processing method includes transmitting, receiving, and prohibiting. The transmitting is configured to transmit to a first apparatus, first scene information regarding a first scene of a plurality of scenes included in a first content. The receiving is configured to receive first information indicating that the first scene is not stored in the first apparatus. The prohibiting is configured to prohibit deletion of the first scene based on the first information.

First, an outline of scene reproduction serving as a premise of scene recommendation processing will be described, then the scene recommendation processing will be described and, finally, details (including calendar function, etc.) of the scene reproduction will be described. In the detailed description of the scene reproduction, a reproduction apparatus (TV apparatus 300) for achieving the scene recommendation processing will be also described. In the present embodiment, “content” and “program” are used as synonymous terms.

(Outline of Scene Reproduction)

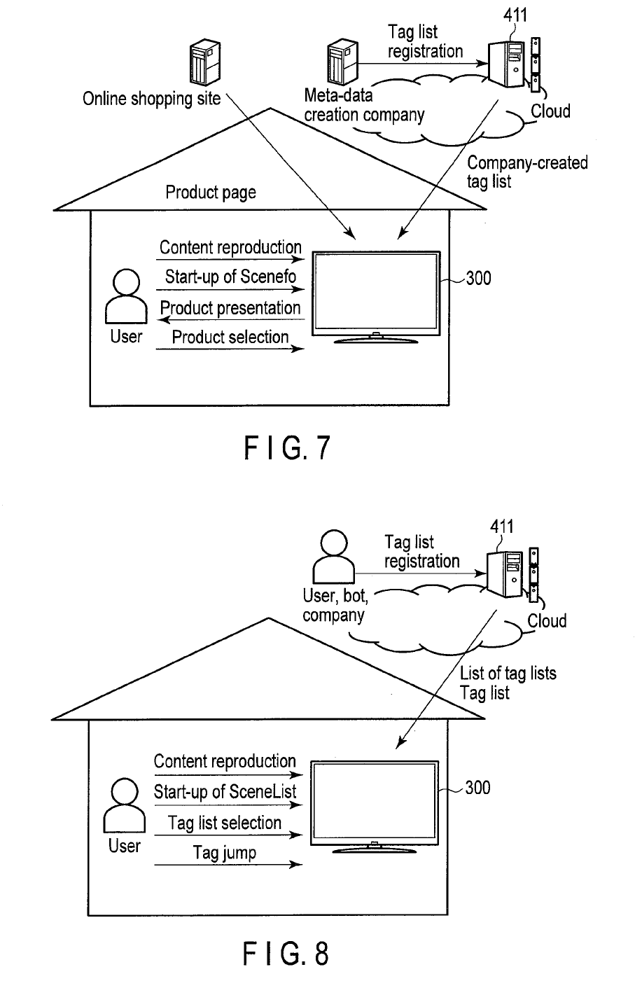

FIGS. 7 to 9 are views each illustrating an outline of a system configuration according to the embodiment. A system according to the present embodiment includes various servers (tag list server, metadata creation server, online shopping site server) and a reproduction apparatus (TV apparatus 300). In the present embodiment, although a case will be described, where the television apparatus 300 is used as a reproduction apparatus in this system, the reproduction apparatus used in the system is not limited to the television apparatus 300. For example, any device which has a user interface, a communication function, a content processing function, a content output function, and a storage function may be used as the reproduction apparatus. A digital recorder, a mobile terminal, and the like can be taken as an example of such a device.

The following describes “Scenefo/SceneList/ScenePlay” application which is a time cloud function installed in the television apparatus 300. The Scenefo refers to scene information. The SceneList refers to a list of the scene information. The ScenePlay refers to reproduction using the scene information.

The time cloud is a service connecting a tag or scene information created by a metadata creation company, a user, or a bot to video content and includes the following three functions.

<Scenefo>

As illustrated in FIG. 7, the Scenefo is a function of providing the scene information of an interesting scene that is being reproduced. A tag List® used here is a company-created tag list provided by a metadata creation company. In place of the company-created tag list, a user-created tag list created by a user may be used.

As illustrated in FIG. 7, the present system allows the following services to be provided through processing to be described later.

0. Tag list registration

1. Content reproduction

2. Start-up of Scenefo

3. Transmission/reception of company-created tag list

4. Product representation (display)

5. Product selection (input operation)

6. Provision of product page (display)

<SceneList>

As illustrated in FIG. 8, the SceneList is a function for a user to selectively view only his or her desired scene during reproduction. The user selects his or her desired scene from a tag list included in various tag lists, such as a user-created tag list, a tag-bot tag list, a company-created tag list provided by the metadata creation company and views the selected scene.

0. Tag list registration

1. Content reproduction

2. Start-up of SceneList

3. Transmission/reception of list of tag lists

4. Tag list selection (input operation)

5. Transmission/reception of tag list

6. Tag jump

<ScenePlay>

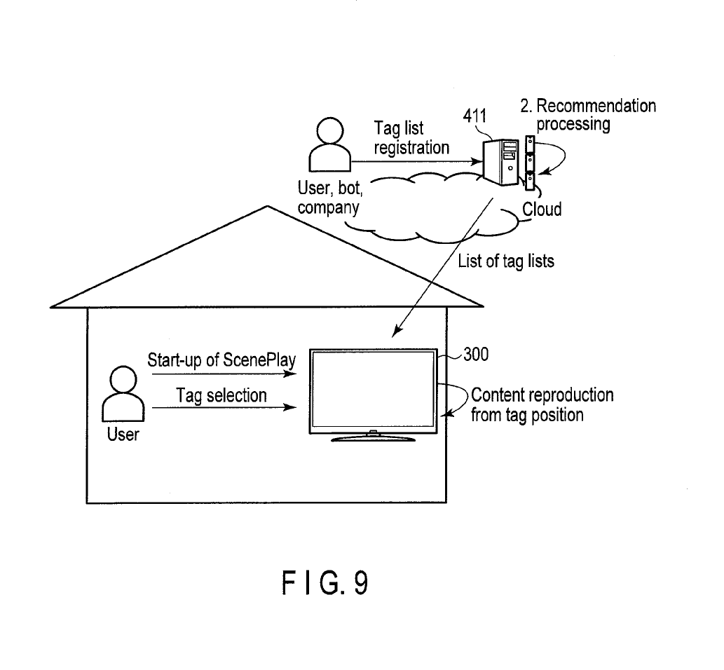

As illustrated in FIG. 9, the ScenePlay is a function for a user to search a large number of scene information items of reproducible video content for an interesting scene and view it. The user finds an interesting scene from recommended scenes, and selects and views it. In this function, various tag lists, such as the user-created list, tag-bot tag list, company-created tag list provided by the metadata creation company can be used.

0. Tag list registration

1. Start-up of ScenePlay

2. Recommendation processing

3. Transmission/reception of tag list

4. Tag selection (input operation)

5. Content reproduction from tag position

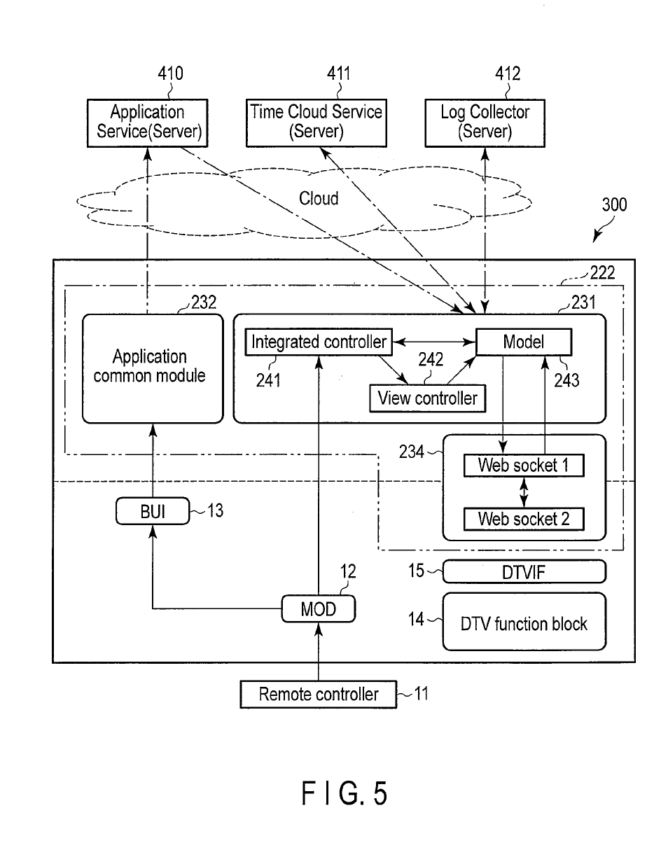

FIG. 5 is a view illustrating an example of a schematic configuration of the reproduction apparatus according to the embodiment. The television apparatus 300 includes a plurality of modules for realizing the Scenefo function, SceneList function, and ScenePlay function, as well as, a module for content reproduction and content recording which are basic functions of the television and a module for searching of the content, scene, and the like and transmission of the scene information.

(Scene Recommendation Processing)

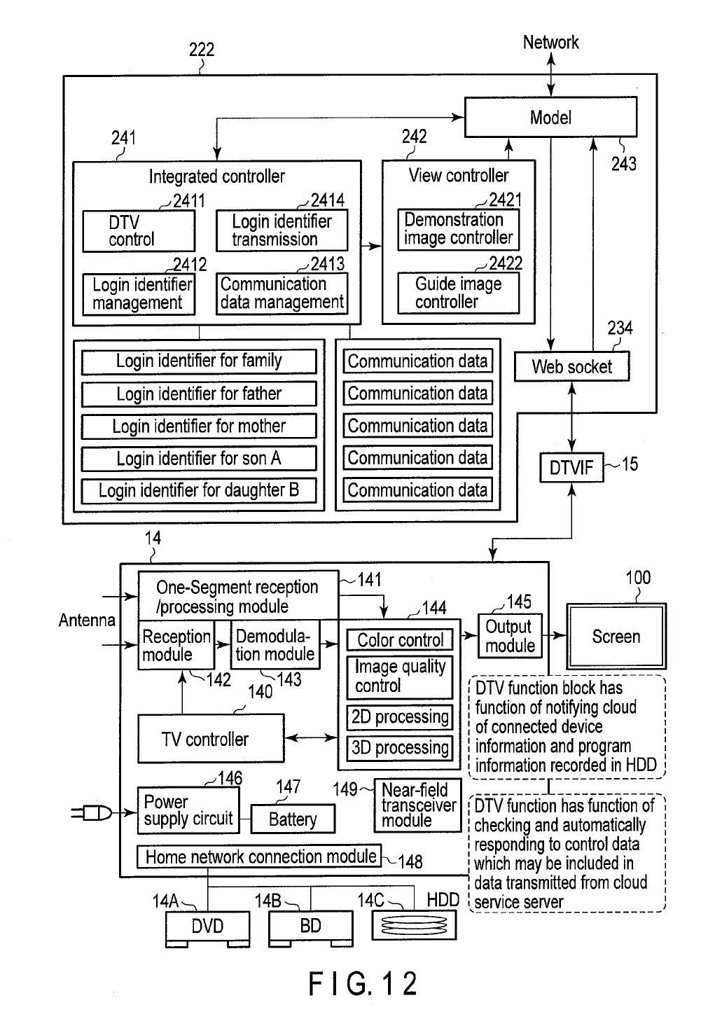

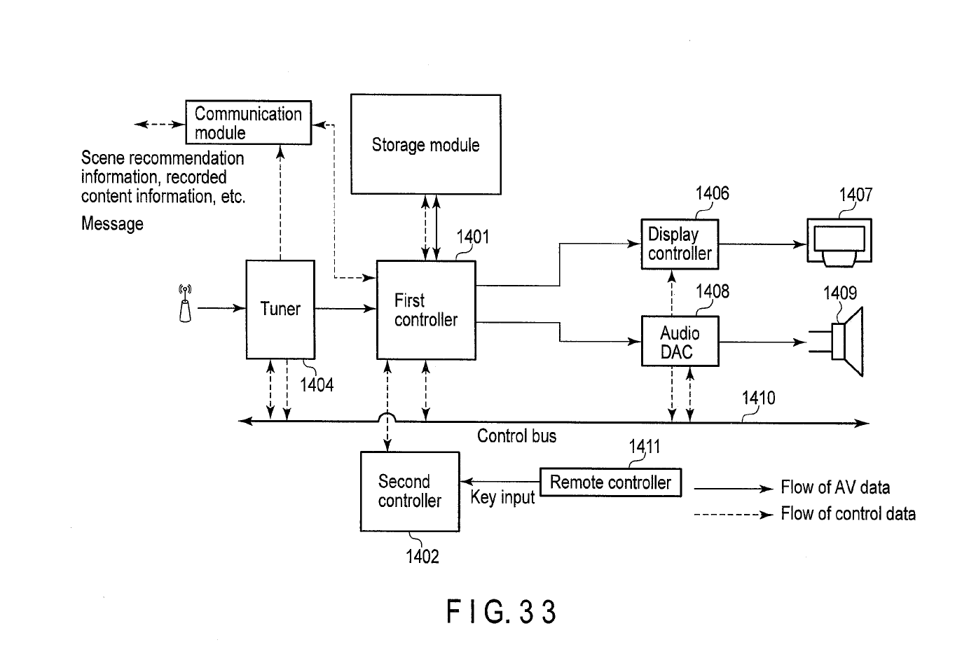

FIG. 33 is a view illustrating an example of a schematic configuration of a digital television functional block 14 of the television apparatus 300. FIG. 12 also illustrates an example of the schematic configuration of the digital television functional block 14 in another way.

As illustrated in FIG. 33, the digital television functional block 14 includes a first controller 1401, a second controller 1402, a communication module 1403, a tuner 1404, a storage module 1405 (for example, hard disk), a display controller 1406, a display module 1407, an audio DAC 1408, a speaker 1409, and a control bus 1410. The first controller 1401, second controller 1402, communication module 1403, tuner 1404, display controller 1406, and audio DAC 1408 are connected to the control bus 1401 and transmit/receive control data among them through the control bus 1401.

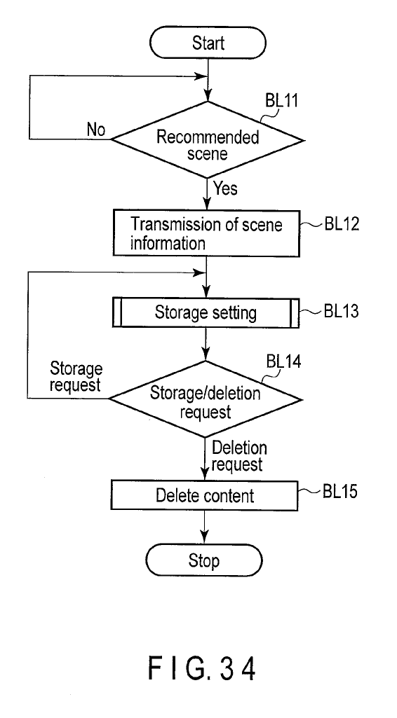

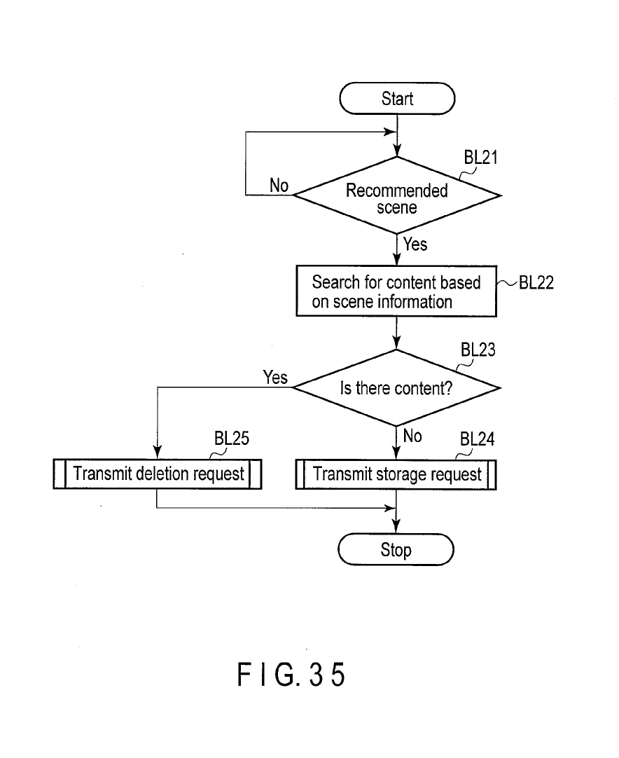

The following describes an example of the scene recommendation processing with reference to FIGS. 34 and 35.

First, recording of the content in the television apparatus 300 and handling of the recorded content therein will be described.

For example, when the television apparatus 300 automatically records therein the content or scene of one or more channels, the automatically-recorded content or scene is stored in a first area of the storage module 1405 for a designated time period. Afterward, however, the automatically-recorded content or scene is deleted or overwritten by other content or another scene. In other words, the content or scene stored in the first area of the storage module 1405 is not protected. On the other hand, when the television apparatus 300 records therein designated content or scene of a designated channel, the designated content or scene is stored in a second area of the storage module 1405. In this case, the stored content or scene can be freely deleted by a user.

Subsequently, reception of the scene information will be described.

For example, when the television apparatus 300 automatically records therein a plurality of content items or scenes, the television apparatus 300 stores therein the content or scenes for a designated time period and transmits information concerning the recorded content or recorded scenes to a server. The server receives the information concerning the recorded content or recorded scenes and transmits, to the television apparatus 300, a plurality of scene information corresponding to a plurality of scenes included in the recorded content or a plurality of scene information corresponding to the recorded scenes. The television apparatus 300 can receive these scene information and display the scene information as a scene list.

For example, the television apparatus 300 (first television apparatus 300) can reproduce (display) one or more scene information of a first recorded content while reproducing the first recorded content. For example, when a user designates first scene information as recommended scene information through a remote controller 1411 or the like (YES in BL11) and designates an external apparatus (different television apparatus 300 [second television apparatus 300]) as a transmission destination of the first scene information, the first television apparatus 300 transmits the designated scene information (recommended scene information) to the second television apparatus 300 (BL12). The first television apparatus 300 can transmit a message together with the recommended scene information. The second television apparatus 300 can receive the recommended scene information and message and display the message. For example, the message includes a name of the user who recommends the scene and a comment. In this manner, the user of the first television apparatus 300 can transmits a recommended scene to an arbitrary person (user of second television apparatus 300) during reproduction of a program.

The first television apparatus 300 performs storage setting for the first recorded content including the scene (recommended scene) corresponding to the recommended scene information or performs storage setting for the recommended scene upon transmission or after completion of transmission of the recommended scene information (BL13). For example, the first television apparatus 300 sets a protection flag to the first recorded content or recommended scene in the storage setting for the first recorded content or recommended scene. The first television apparatus 300 prohibits deletion of the first recorded content or recommended scene to which the protection flag is set. The first television apparatus 300 retains the first recorded content or recommended scene and prohibits deletion thereof until reception of a reply from the second television apparatus 300.

The second television apparatus 300 receives the recommended scene information from the first television apparatus 300 (YES in BL21) and searches for the first recorded content including the recommended scene corresponding to the recommended scene information or the recommended scene (BL22).

When the second television apparatus 300 cannot retrieve the first recorded content or recommended scene, that is, when the second television apparatus 300 does not store therein the first recorded content or recommended scene (NO in BL23), the second television apparatus 300 transmits, to the first television apparatus 300, first information indicating that the first recorded content or recommended scene is not stored (or first information instructing the first television apparatus 300 to retain the first recorded content or recommended scene even after elapse of a designated time period) (ST4).

When the second television apparatus 300 can retrieve the first recorded content or recommended scene, that is, when the second television apparatus 300 stores therein the first recorded content or recommended scene (YES in BL23), the second television apparatus 300 transmits, to the first television apparatus 300, second information indicating that the first recorded content or recommended scene is stored (or second information instructing the first television apparatus 300 to delete the first recorded content or recommended scene) (BL25).

Upon reception of the first information (“Storage request” in BL14), the first television apparatus 300 updates the storage setting for the first recorded content or recommended scene based on the first information (BL13). For example, based on the first information, the first television apparatus 300 prohibits deletion of the first recorded content or recommended scene and retains the first recorded content or recommended scene even after elapse of a designated time period. Moreover, based on the first information, the first television apparatus 300 outputs (displays) confirmation information on whether or not to retain the first recorded content or recommended scene even after elapse of a designated time period. When a user issues the “store” instruction to the first television apparatus 300 through the remote controller 1411 or the like, the first television apparatus 300 prohibits the deletion of the first recorded content or recommended scene based on the storage instruction and retains the first recorded content or recommended scene even after elapse of a designated time period.

Upon reception of the second information (“Deletion request” in BL14), the first television apparatus 300 updates the storage setting for the first recorded content or recommended scene based on the second information. For example, based on the second information, the first television apparatus 300 deletes the first recorded content or recommended scene after elapse of a designated time period (BL15). Moreover, based on the second information, the first television apparatus 300 outputs (displays) confirmation information on whether or not to delete the first recorded content or recommended scene after elapse of a designated time period. When a user instructs the first television apparatus 300 to delete the first recorded content or recommended scene through the remote controller 1411 or the like, the first television apparatus 300 deletes the first recorded content or recommended scene based on the deletion instruction after elapse of a designated time period.

The first information will be described more in detail.

For example, the first information can include first designation information for designating a storage destination (HDD, SD card, Blu-ray®, DVD, etc.). The first television apparatus 300 stores the first recorded content or recommended scene in a designated storage destination based on the first designation information included in the first information.

Moreover, the first information can include second designation information for designating a format (BD-AV, BD-MV, AVC-REC, DVD-VR, DVD-Video, etc.). The first television apparatus 300 stores the first recorded content or recommended scene in a designated format based on the second designation information included in the first information.

Moreover, the first information can include third designation information for designating a recording mode (recording rate, image quality, sound quality, etc.). The first television apparatus 300 stores the first recorded content or recommended scene in a designated mode based on the third designation information included in the first information. For example, the recording mode may represent storage type (direct storage or compressed storage) and rate designation (average rate or fixed rate).

The first information can include at least one of the first to third designation information.

As described above, the first television apparatus 300 records the content or scene in a constant recording area in an automatic recording mode and records the designated content or scene in a storage area in a designation recording mode. For example, programs of a plurality of channels are recorded in the automatic recording mode over 24 hours. However, the programs recorded in the automatic recording mode are stored only for a designated time period under the restriction of storage capacity. Thus, after elapse of the designated time period, the programs recorded in the constant recording area are automatically deleted. Therefore, in the case where the first recorded content or recommended scene is stored in the constant recording area, when receiving the first information, the first television apparatus 300 copies or moves the first recorded content or recommended scene stored in the constant recording area to the storage area.

A user of the second television apparatus 300 which is a television apparatus on a reception side does not always want to view the recommended scene corresponding to the recommended scene information. Thus, upon reception of the recommended scene information, the second television apparatus 300 may display a screen for conformation of whether to search for the first recorded content including the recommended scene corresponding to the recommended scene information or recommended scene corresponding thereto. Further, alternatively, when the second television apparatus 300 stores the first recorded content or recommended scene, the second television apparatus 300 may display a screen for confirmation of whether to exclude the first recorded content or recommended scene from the deletion target. When the user uses the remote controller 1141 or the like to instruct the second television apparatus 300 to perform the search, the second television apparatus 300 searches for the first recorded content or recommended scene. When the user uses the remote controller 1141 or the like to instruct the second television apparatus 300 to exclude the first recorded content or recommended scene from the deletion target, the second television apparatus 300 excludes the first recorded content or recommended scene from the deletion target. Alternatively, when the user uses the remote controller 1141 or the like to issue an instruction to allow the first recorded content or recommended scene to be deleted after elapse of a designated time period, the second television apparatus 300 deletes the first recorded content or recommended scene after elapse of a designated time period. As described above, by confirming user's intention and executing processing in accordance with the user's intention, the storage area can be effectively used.

Meanwhile, the first television apparatus 300 which is a television apparatus on a transmission side may perform processing for retaining the first recorded content or recommended scene even after elapse of a designated time period in a previously designated time zone (for example, nighttime). For example, the first television apparatus 300 receives setting of start time of the storage processing and performs the processing for retaining the first recorded content or recommended scene even after elapse of a designated time period at the set start time. Further, the first television apparatus 300 can perform the processing for retaining the first recorded content or recommended scene even after elapse of a designated time period while avoiding recording reservation time of content.

Moreover, the first television apparatus 300 which is a television apparatus on a transmission side can transmit the recommended scene information to a plurality of television apparatuses 300. In this case, the first television apparatus 300 prohibits deletion of the first recorded content or recommended scene until reception of a reply from the television apparatuses 300. Moreover, when receiving the second information from at least one of the television apparatuses 300, the first television apparatus 300 prohibits deletion of the first recorded content or recommended scene and retains the first recorded content or recommended scene even after elapse of a designated time period.

For example, the first television apparatus 300 transmits the recommended scene information to the second television apparatus 300 and a third television apparatus 300. In this case, even when receiving the second information from the second television apparatus 300 first, the first television apparatus 300 does not delete the first recorded content or recommended scene after elapse of a designated time period. Afterward, when receiving the second information from the third television apparatus 300, the first television apparatus 300 deletes the first recorded content or recommended scene after elapse of a designated time period, or when receiving the first information from the third television apparatus 300, the first television apparatus 300 retains the first recorded content or recommended scene even after elapse of a designated time period.

Moreover, the first television apparatus 300 may access an external server to receive format information corresponding to the second television apparatus 300 and store the first recorded content or recommended scene based on the received format information. This allows the first television apparatus 300 to store the first recorded content or recommended scene in a format (optimum format) supported by the second television apparatus 300.

The above description of the present embodiment will be summarized below.

(1) The transmission-side first television apparatus 300 of the embodiment transmits the recommended scene information to the reception-side second television apparatus 300. The second television apparatus 300 receives the recommended scene information, searches for the first recorded content including the recommended scene corresponding to the recommended scene information or recommended scene corresponding thereto, and transmits the first or second information depending on a result of the search. The first information is information indicating that the first recorded content or recommended scene is not present (stored) or information instructing the first television apparatus 300 to retain the first recorded content or recommended scene even after elapse of a designated time period. The second information is information indicating that the first recorded content or recommended scene is present (stored) or information instructing the first television apparatus 300 to delete the first recorded content or recommended scene after elapse of a designated time period. When receiving the first information, the first television apparatus 300 retains the first recorded content or recommended scene even after elapse of a designated time period based on the received first information. On the other hand, when receiving the second information, the first television apparatus 300 deletes the first recorded content or recommended scene after elapse of a designated time period based on the received second information.

(2) The second television apparatus 300 receives the recommended scene information and displays the confirmation information on whether or not the first recorded content including the recommended scene corresponding to the recommended scene information or recommended scene corresponding thereto is necessary. When a user inputs information indicating the necessity of the first recorded content or recommended scene through the remote controller 1411 or the like, the second television apparatus 300 searches for the first recorded content or recommended scene and transmits the first or second information depending on a result of the search.

(3) The first information can include the first designation information for designating a storage destination (HDD, SD card, Blu-ray®, DVD, etc.). Moreover, the first information can include the second designation information for designating a format (BD-AV, BD-MV, AVC-REC, DVD-VR, DVD-Video, etc.). Moreover, the first information can include the third designation information for designating a recording mode (recording rate, image quality, sound quality, etc.).

(4) The first television apparatus 300 receives information concerning the second television apparatus 300 by way of a server and stores, based on the received information, the first recorded content or recommended scene using an optimum method. For example, when the second television apparatus 300 supports a first recording format, the first television apparatus 300 stores the first recorded content or recommended scene in the first recording format. When the second television apparatus 300 is provided with an SD card slot, the first television apparatus 300 stores the first recorded content or recommended scene in the SD card.

(5) The first television apparatus 300 stores the first recorded content or recommended scene at the set storage start time.

(6) The first television apparatus 300 does not delete the first recorded content or recommended scene but retains it until reception of a reply from a transmission destination of the recommended scene information. For example, when the first television apparatus 300 transmits the recommended scene information to a plurality of transmission destinations, the first television apparatus 300 does not delete the first recorded content or recommended scene but retains it until reception of a reply from the transmission destinations.

With the above configuration, the following effects can be obtained.

(1) Information exchange between the transmission-side first television apparatus 300 and reception-side second television apparatus 300 allows ensuring of an opportunity of viewing the recommended scene information, thereby enhancing convenience.

(2) It is possible for the transmission-side first television apparatus 300 to store or delete the content or recommended scene in accordance with intention of the user of the second television apparatus 300. This allows effective use of the recording area of the transmission-side first television apparatus 300.

(3) The reception-side second television apparatus 300 has a Blu-ray® recorder, the second television apparatus 300 transmits information indicating that it has the Blu-ray® recorder, so that the transmission-side first television apparatus 300 stores the content or recommended scene in a Blue-ray®. This facilitates delivery and receipt of the content of recommended scene.

(4) Designation of the recording mode by the reception-side second television apparatus allows, for example, the transmission-side first television apparatus 300 to store long-duration content or ling-duration recommended scene only in a single medium. This can reduce the number of media to be used.

(5) The transmission-side first television apparatus 300 sets the storage time of the content or recommended scene, whereby the content or recommended scene can be stored in a time zone during which operation load is small.

(6) The transmission-side first television apparatus 300 retains the content or recommended scene even after elapse of a designated time period until reception of a reply from the reception-side second television apparatus 300.

(7) When the transmission-side first television apparatus 300 transmits the recommended scene information to a plurality of the reception-side second television apparatuses 300, the first television apparatus 300 does not delete the content or recommended scene but retains it until reception of a reply from these reception-side second television apparatuses 300. This can avoid situations where a user of one of the reception-side second television apparatuses 300 cannot view the content of the scene corresponding to the recommended scene information or recommended scene corresponding thereto. Further, if a reply from a given television apparatus 300 is delayed, a user of the given television apparatus 300 can be prevented from losing an opportunity of viewing the content or recommended scene.

Although the recorded content or recommended scene is taken as the recording target in the above description, the recorded content or recommended scene may be broadcast content or a broadcast scene, or a network-delivered content or a network-delivered scene.

The first and second television apparatuses 300 may communicate with each other directly or through a server. The scene information recommendation processing is not a function limited to a stationary television apparatus 300, but a tablet-type content reproduction device may be used to realize the scene recommendation processing. For example, the above scene information recommendation processing can also be realized by utilizing the first television apparatus 300, a tablet-type content reproduction device capable of communicating with the first television apparatus 300, the second television apparatus 300, and a tablet-type content reproduction device capable of communicating with the second television apparatus 300.

The television apparatus 300 can perform the scene information recommendation processing by utilizing a SynchroViewing function. For example, the first television apparatus 300 can register therein the second television apparatus 300 (address) serving as a target of the SynchroViewing function. The SynchroViewing function allows the first television apparatus 300 to share program recording reservation, program viewing reservation, and the like with the second television apparatus 300, which in turn allows owners of the first and second television apparatuses 300 can view the same content or the same scene.

For example, assume that the first television apparatus 300 is installed in Tokyo and second television apparatus 300 is installed in Osaka. In Tokyo, the first content or first scene has already been broadcast and, thus, the first television apparatus 300 can record the first content or first scene in a hard disk, etc. That is, the first television apparatus 300 retains the first recorded content or first scene by using the hard disk, etc. On the other hand, in Osaka, the first content or first scene has not yet been broadcast or is not planned to be broadcast. In this case, the second television apparatus 300 cannot record therein the first content or first scene.

In the above situation, it is assumed that the second television apparatus 300 receives the scene information from the first television apparatus 300. If the second television apparatus 300 does not record therein the first content including the first scene corresponding to the scene information or the first scene corresponding thereto, the second television apparatus 300 transmits the first information to the first television apparatus 300. The first television apparatus 300 receives the first information and retains the first recorded content or first recorded scene stored in a hard disk even after elapse of a designated time period. Moreover, the first television apparatus 300 stores the first recorded content or first recorded scene in a designated storage destination (for example, optical disk). In this case, for example, the first television apparatus 300 may delete the first recorded content or first recorded scene stored in the hard disk. This allows the owner of the first television apparatus 300 to easily pass, to the owner of the second television apparatus 300, the optical disk in which the first recorded content or first recorded scene is stored.

All procedures of the processing (scene information recommendation processing) described above can be executed by software. Thus, simply by installing a computer program executing the procedures of the above processing in a common computer through a computer-readable storage medium storing the computer program and executing the computer program, the above processing can easily be realized.

For example, the television apparatus 300 can install therein the computer program by downloading the computer program and storing the downloaded computer program. This allows the television apparatus 300 equivalent to the computer to easily realize the above processing according to the installed computer program.

Moreover, the television apparatus 300 can install therein the computer program by reading out the computer program from a computer-readable storage medium and storing therein the read out computer program.

(Details of Scene Reproduction)

Hereinafter, the “TV apparatus 300” and an “electronic apparatus” are used as a synonymous term.

An electronic apparatus according to one embodiment includes a means for displaying viewing content and a list of service menus associated with the viewing content upon reception of an instruction of starting up a cloud service during reproduction of the content and a means for switchably displaying the service menus depending on a display state.

Further, according to another embodiment, the electronic apparatus includes a network-connectable integrated controller and a view controller. When the integrated controller is not communicably connected to the network, the view controller can demonstrate a menu image which is supposed to obtain when the integrated controller is communicably connected to the network.

The integrated controller includes a login data management module and a communication data management module. The login data management module manages a common login identifier shared among a plurality of users and a dedicated login identifier for each individual. The communication data management module distinguishes between communication data corresponding to the common login identifier and communication data corresponding to the dedicated login identifier so as to select a display output.

When the common login identifier is in a login state, the communication data management module performs control to keep the communication data corresponding to the dedicated login identifier private.

The server may manage a login state and a logout state of each of a large number of electronic apparatuses (clients) using a table. The login management module may periodically transmit a currently logged-in login identifier to the server. This allows the server to correctly grasp the login state of each of the large number of electronic apparatuses (clients).

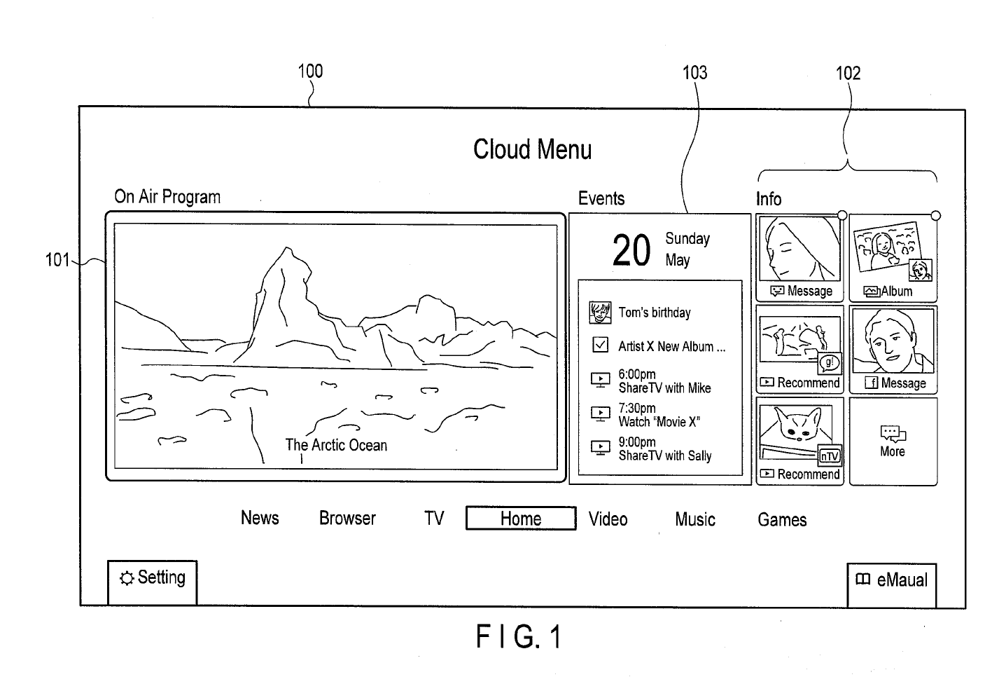

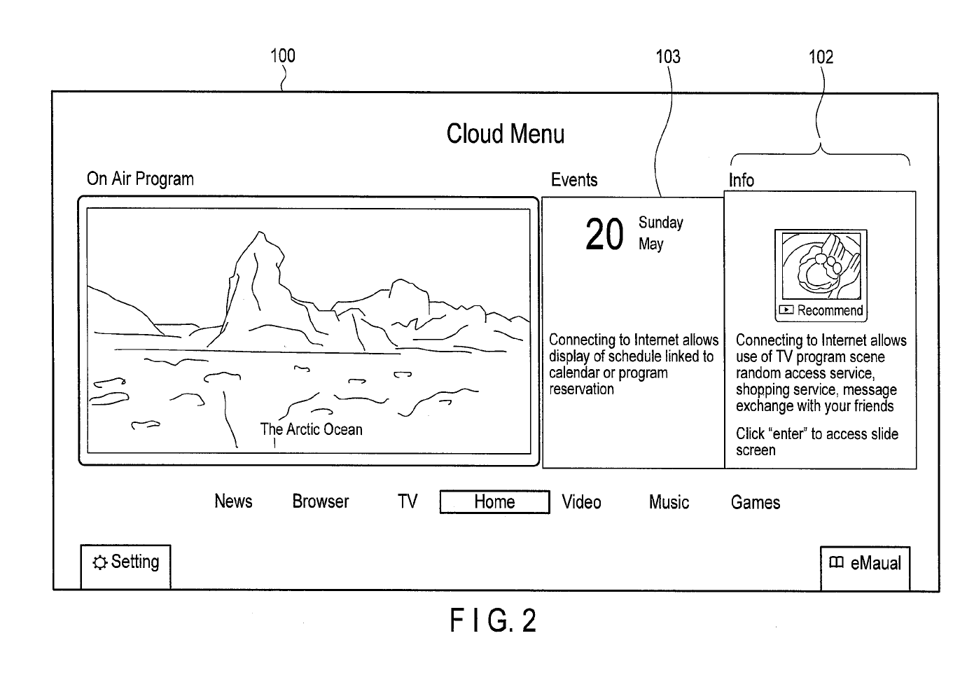

FIGS. 1 and 2 each illustrate an example of the menu image in a demonstration state. In a display area 101 positioned on a left side of a screen 100, a video image of a program being broadcast or a video image being reproduced from a recorder is displayed. In a display area 102 positioned on a right of the screen 100, a plurality of thumbnail guide images are displayed one after another such that the number of the guide images are increased as 1, 2, 3, . . . . After the number of the guide images in the display area 102 reaches, for example, 6 (FIG. 1), a message saying, for example, “connecting to Internet allows use of television program scene random access service, shopping service, message exchange with your friends” is displayed in the display area 102, as illustrated in FIG. 2. In a center display area 103, a calendar is displayed together with summary of information about today's events (FIG. 1). Moreover, in the center display area 103, a message saying, “Connecting to Internet allows display of schedule linked to calendar or program reservation” is displayed as illustrated in FIG. 2.

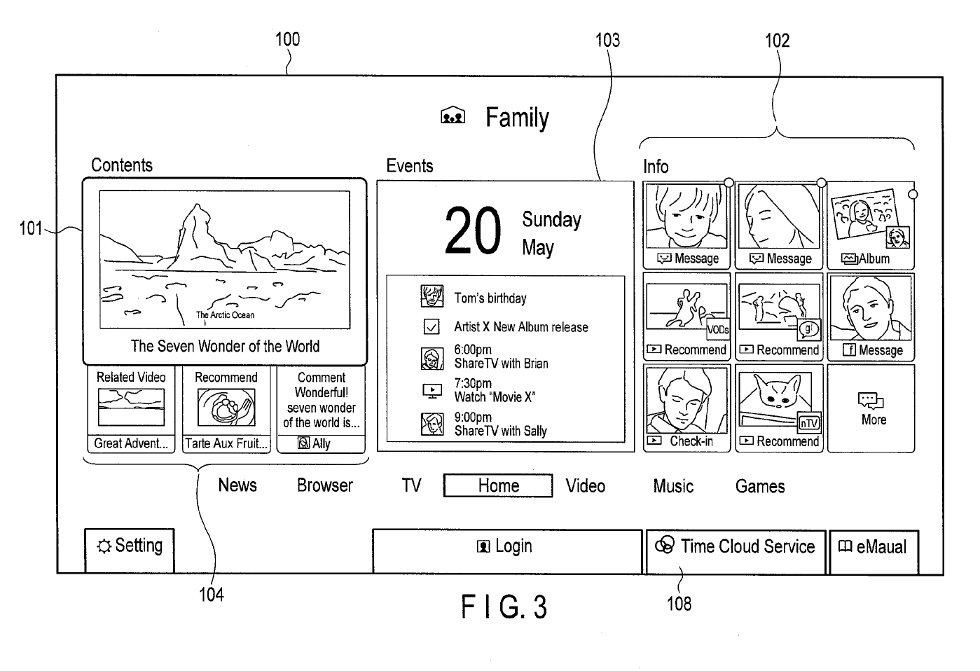

FIG. 3 illustrates a display state of the screen 100 when the electronic apparatus is connected to the Internet and login is made using a family ID. In the display area 102, guide images for various mailboxes for receiving notification and recommended data from family members or friends are displayed. Examples of the mailbox include those for Outlook®, mail, message, and recommended data. A unique name can be added to a window frame representing each mailbox. Further, it is possible to select a favorite image from among various images in image files and to add the selected image to the mailbox window frame as the guide image. When a new message or new recommended data exists in the mailbox, a circle is added to the corresponding guide image, the color of the window frame is changed, or the brightness of the window frame is repeatedly changed. Further, when a plurality of new recommended data exist in the mailbox, a plurality of circles may be added to the corresponding guide image. Alternatively, a number indicating the number of the received recommended data may be displayed.

The above-described mailbox (display area 102 of FIG. 3) can be used for communication among family members, communication between a family member and a friend, and the like. There may be a case where a photo album is sent from a friend or a faraway brother. Further, there may be a case where the recommended data is sent from a friend. Examples of the recommended data include recommended program information, recommended shopping information, recommended scene information, and recommended cast information. A usage example of the guide image will be described later.

Further, a plurality of function-related guide images are displayed in a display area 104 positioned on a lower side of area 101. The function-related guide image is used when a user operates the electronic apparatus with respect to a reproduction image displayed in area 101. Although details of a usage example of this guide image will be described later, this guide image can be used when communication associated with the reproduction image displayed in area 101 is performed between a user and an external server (another user).

<Usage Example of Guide Image in Display Area 102>

A user can move a cursor (or focus) to a desired guide image (for example, guide image for message from a mother to her child) by operating, for example, a remote controller (there may be a case where a mobile terminal has a remote controller function). The guide image may be referred to as an operation button. The cursor is displayed as, for example, a frame surrounding the guide image. Alternatively, a guide image focused by the cursor becomes brighter than other guide images, that is, highlighted. In a state where the cursor is placed on a desired guide image, an enter button of the remote controller is pressed (or click button is clicked). Then, a mailbox corresponding to the guide image is opened and, for example, a message is displayed. For example, as a message area, the entire or half of area 102 can be used.

The user can open the mailbox of the recommended data by operating the remote controller. The recommended data may be, for example, recommended program information or recommended shopping information sent from a friend. Assume that the user is interested in the recommended program corresponding to the recommended program information and wants to view the program. Then, the user moves the cursor to a selection button corresponding to the displayed recommended program information and presses the enter button, causing the television apparatus to start reproduction of the program. In this case, a reproduction image of the program is displayed in a small window. When the user presses the enter button once more, the reproduction image of the program is displayed in a large window.

The mailbox can also be used for sending a message to a mailbox or mobile terminal of a communication partner. The recommended program information is displayed as, for example, a title name, some scenes in the program, cast names, or cast images. The recommended program information includes information concerning a channel number of the program, an air date/time, casts, a casts prologue, a content server address, and the like.

A method for the television apparatus to acquire program content includes a first method and a second method. The first method is a method of acquiring the program content by driving a recorder connected to the television apparatus, and the second method is a method of acquiring the program content by downloading the content from a content server over the Internet. In the first method, a program list search function for searching programs recorded in the recorder runs. In the second method, an address for accessing a server having content included in the recommended program information is used.

The recommended program information may include data processed so as to make it easier for the user to acquire the program content. That is, the recommended program information from a friend is uploaded from an apparatus of the friend to the server. Then, in this server, the recommended program information is processed to program information that can be used by the user. The reason that the processing is performed is that a broadcast program may differ in channel number, air date/time, and the like from one region to another. Therefore, the program information is once processed (for, for example, channel number and air date/time are processed) in the server so as to make it easier for the user to retrieve the program recommended by the friend and is then provided to the user. The method of acquiring the recommended program information further includes a method that uses a calendar, which will be described later.

Further, by using the guide image in the display area 102, it is possible to send a mail, a short message, and the like to a family member or a friend registered in a management module for managing the guide image. The friend in this case is a friend common to the family members. Information concerning another family or friends common to the family members is recognized and registered by a family managing unit that stores and manages guide images for family.

<Usage Example of Guide Image in Display Area 104>

For example, assume that there is a scene that the user likes or a scene where the user's favorite cast appears in a drama program (displayed in area 101) that he or she is viewing. In such a case, the user operates the remote controller to select the recommended guide image and press the enter button. Then, program information of the program viewed by the user is uploaded to the server as attention (or notice) program information. The server can use the attention program information as a material for creation of the recommended program information and/or a material for creation of a tag list of the program. Since attention program information of various programs are sent from many viewers, the server can perform statistical processing by using the attention program information. Based on a result of the statistical processing, it is possible to create a program information list listing programs in descending order of popularity.

The user can select a guide image for comment and press the enter key by operating the remote controller. Then, a window for inputting a short message with respect to a program (program image displayed in area 101) that the user is viewing appears, and the user can input a message. The message can be input using the remote controller or a keyboard display of a mobile terminal.

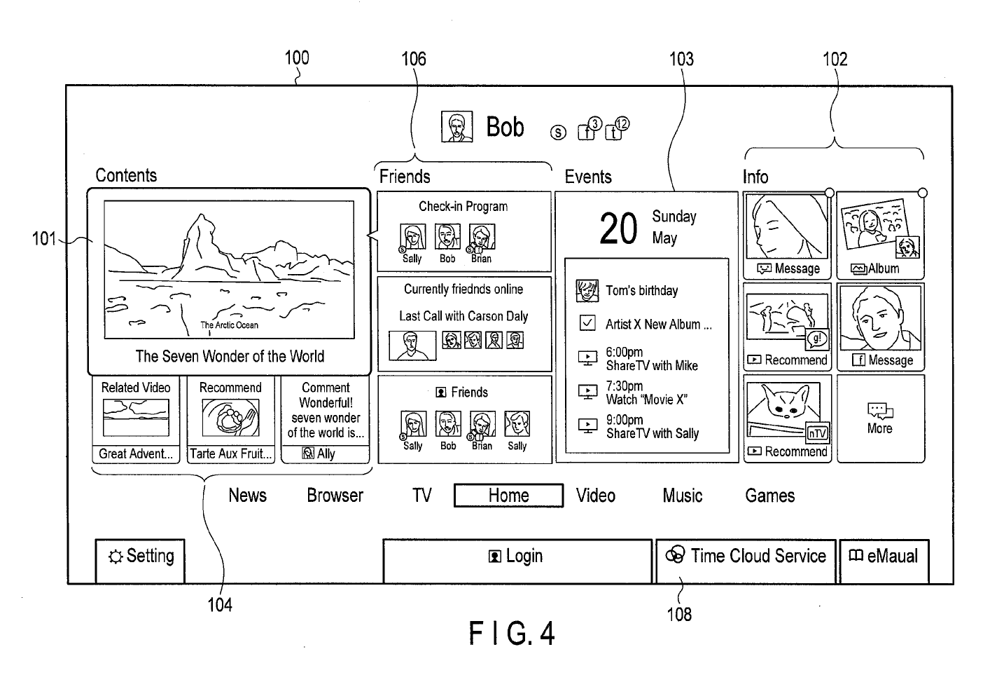

FIG. 4 illustrates a display state of the screen 100 when the electronic apparatus is connected to the Internet and login is made using a private ID. On the screen 100, a display area 106 of the guide image for facilitating communication with a friend may be arranged between area 101 and area 103. For example, guide images of three types exist in the display area 106. An upper guide image (Check-in to Program) displays a list of friends who are viewing the same program as that the user is currently viewing. A middle guide image (Friends currently online) displays a list of friends whose electronic apparatuses are connected to a network but who are viewing a different program from that the user is currently viewing. A lower guide image (Friends) displays a list of friends whose electronic apparatuses are not connected to the network. The login state of the electronic apparatus is periodically transmitted to the server. Thus, the server can distinguish between a user who is not connected to the network, a user who is connected to the network, and a user who is connected to the network and is viewing the same program. The server monitors statuses of a plurality of users. Thus, the electronic apparatus can present the guide images of three types as illustrated in the display area 106.

<Usage Example of Guide Image in Display Area 106>

For example, there may be case where a son B of a friend A appears in a drama program that the user is viewing and where the user wants to inform the friend A or his or her family member of this. Moreover, there may be a case where a friend A looks for a lost dog C and the user who views a news of the lost dog C wants to inform the friend A or his or her family member of this. In the cases as described above, the user can use the guide image displayed in area 106.

The user can select the guide image displaying a desired friend using the cursor and press the enter button by operating the remote controller. Then, a window on which a massage can be sent to the selected friend appears.

The above-described communication can be made by using the guide message displayed in the display area 102 together with a recommendation or a message. The user can select the guide image displaying a desired image using the cursor and press the enter button by operating the remote controller. This allows the user to send a message to a family member or a person registered in the mailbox corresponding to the selected image. The guide image in the display area 106 can be used mainly for private communication.

<Usage Example of Guide Image in Display Area 103>

The guide image in the display area 103 displays a calendar, as well as displays today's events or schedule titles in a simple manner. When the user wants to know detailed information about the event or schedule, he or she selects a title of the event or schedule using the cursor and clicks the selected title, whereby the detailed information is displayed. The detailed information may be made browsable by, for example, a URL.

A user's schedule and the like can also be written to the calendar. When the display area of the calendar is selected by the cursor, use items of the calendar are displayed. When the user wants to write his or her schedule to the calendar, he or she can select a “schedule write item” and input his or her schedule to the calendar by using the remote controller or mobile terminal.

<Transfer of Operation Screen>

The guide image illustrated in FIGS. 2, 3, and 4 can be displayed on a mobile terminal having a touch-type input operation module serving also as a display, excluding the viewing image in area 101. That is, the electronic apparatus can transfer the guide image and an operation signal corresponding to the guide image to the mobile terminal through a communication function of the television apparatus. This allows the mobile terminal to maintain a communication state with the television apparatus and allows the user of the mobile terminal to operate the electronic apparatus using the guide image in the manner as described above.

<Cloud Service Button>

On the screen 100, a button 108 called, for example, “Time Cloud Service” is displayed (name and position of the button 108 are not limited to those specified in the present embodiment).

Assume that the user who is viewing the content displayed in area 101 selects the cloud service button 108 using the cursor and clicks it to instruct execution of a cloud service. This can activate an application of the cloud service of the present apparatus. When the cloud service is started, viewing content and service menus associated with the content are provided from a time cloud server, and the present apparatus can display a list of the service menus. The service menus can switchably be displayed depending on a display state. The cloud service includes various services and has various types of expansivity. For the cloud service, some typical examples will be described later. The guide image illustrated in FIGS. 2, 3, and 4 may be activated when the button 108 is pressed to establish connection between the present apparatus and time cloud service server. A dedicated key provided in the remote controller may be operated for activating the application of the cloud service.

The connection between the present apparatus and cloud service server may be established by operating the remote controller and/or a specific button provided in the mobile terminal.

<Configuration Example of Functional Blocks of Electronic Apparatus>

FIG. 5 illustrates an entire configuration of the television apparatus 300 to which the electronic apparatus and method according to the embodiment are applied. In FIG. 5, basic functions (reception of television signal, demodulation of television signal, control signal processing, 3D-related signal processing, recording, audio processing, video processing, display function, etc.) of a digital television receiver (DTV) are collectively represented as a DTV functional block (or module) 14. The DTV functional block 14 is connected to an electronic apparatus 222. The electronic apparatus 222 may be referred to as a browser module.

In this example, the electronic apparatus 222 includes a cloud application module 231, an application common module 232, and a socket module 234. This classification is not limited, but the cloud application module 231 may be defined as the electronic apparatus 222.

The socket module 234 includes a server web socket viewed from a DTV interface 15 and a client web server viewed from a browser.

The cloud application module 231 includes an integrated controller 241, a view controller 242, and a model 243. The integrated controller 241 performs various event processing in response to a command and an instruction. The integrated controller 241 controls the view controller 242 to realize various drawing processing. The view controller 242 can acquire various images and various control signals in the screen 100 described above. The images and control signals based on operation of the view controller 242 are reflected as images and control buttons displayed on a display of the television apparatus through the socket 234.

The model 243 performs access to the server, acquisition of information from the server, transmission of information to the server, DTV operation, reception of data from the DTV, and the like. Thus, a message can be received from the DTV, and the received message can be transmitted to the server. Moreover, a message received from the server can be displayed on the screen of the display of the television apparatus in cooperation with the view controller 242. As the server, an application service server 410, a time cloud service server 411, a log collector server 412, and the like are provided. Although not illustrated, other various servers are provided.

The user can control the DTV and electronic apparatus 222 by operating a remote controller 11. An operation signal from the remote controller 11 is sorted by a moderator 12. A key event sorted as a signal for the cloud application module 231 is input to the integrated controller 241. A key event sorted as a signal for the application common module 232 is input to the application common module 232 through a browser interface 13. The application common module 232 can request the application server 410 for a designated application in response to an application request command. The application supplied from the application server 410 is loaded into the cloud application module 231 through the model 243. The log collector server 412 can collect a log used in the electronic apparatus 300 and other apparatus connected thereto.

The time cloud service server 411 can be connected to other various servers and other electronic apparatus over the network. The time cloud service server 411 can send various service data to the electronic apparatus. The time cloud service server 411 can associate video content with scene information or tag list created by a metadata creation company or a user. The associated data is listed in a table.

As a matter of course, the blocks and operations thereof (including operations described above and operations to be described below) illustrated in FIG. 5 may be realized by a set of instructions (which may be refereed to as “computer program”) constituting software. Moreover, as a matter of course, a processor or a central processing unit (CPU) for realizing data processing based on the software may be incorporated in each block illustrated in FIG. 5. The above-mentioned software is stored in a memory (storage medium) and can be upgraded. The data (software) in the memory can be read by a computer.

The DTV has a plurality of digital tuners and can thus receive a plurality of channels simultaneously. When signals of a plurality of channels are demodulated, a plurality of streams can be obtained. Each of the streams includes packets for a television program, a control signal, and the like. The streams of the plurality of programs of the plurality of channels are recorded in, for example, a USB-connected hard disk drive (HDD). The HDD can record management information for managing program information of a recorded program.

<Recording Reservation, Viewing Reservation, Recording History, and Viewing History in DTV>

The television apparatus 300 to which the electronic apparatus and method according to the embodiment are applied has a recording reservation function, a viewing reservation function, a recording history function, and a viewing history function.

The recording reservation function refers to a function in which the user makes reservation of recording a desired program in a desired recorder (HDD, etc.). The recording reservation function creates a program list from, for example, electronic program guide (EPG) data and displays it. The user makes the recording reservation by operating the remote controller to select a desired program using the cursor. This allows the user's desired program to be recorded in, for example, the HDD. In a case where a plurality of recorders are connected over a home network, the user can designate a specific HDD as a recording destination.

The recording history is information concerning a program recorded by the recording reservation function or an automatic recording function. The recording history information includes recording date and hour and program information (data indicating broadcast station name, air date/time, etc.) of the recorded program.

The viewing reservation function is a function of reserving reproduction of a desired program selected from among a large number of programs stored in the HDD. Reservation information of the viewing reservation function includes data indicating an HDD storing the program, a name of the broadcast station that broadcasts the program, a name of the program, reproduction start time of the program, and the like.

The viewing history includes program information (data indicating a recorder, broadcast station name, air date/time, etc.) of the program reproduced in the television apparatus 300.

Information concerning the recording reservation, viewing reservation, recording history, and viewing history can be managed by family members on an individual basis. Moreover, the above information can be managed as public information shared among all the family members. This is possible because the management module manages data concerning the recording reservation, viewing reservation, recording history, and viewing history using login identifiers for both family use and individual use.

<Relationship Between Time Cloud Service Server and Electronic Apparatus>

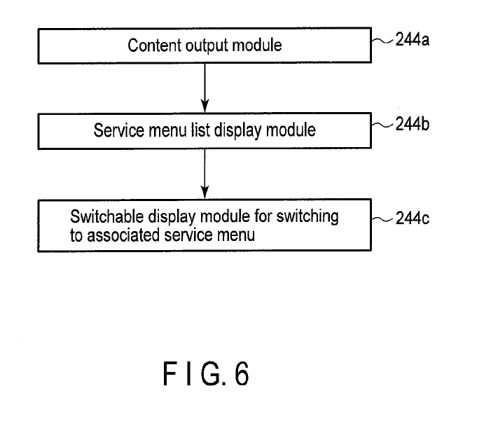

FIG. 6 illustrates a configuration example of a module (which may be software or hardware) constituted by the integrated controller 241, view controller 242, model 243, and the like of FIG. 5. A content output module 244a outputs viewing content to the display. When an instruction requesting a service is input from a predetermined server in a state where the content is displayed on the display, a service menu list display module 244b can make the display a list of the service menus associated with the content. Then, depending on a display state of the service menus, a switchable display module 244c can switchably display additional associated service menus in response to a subsequent designation input. The following describes various service functions related to this function.

<Scene Information Function (Scenefo)>

FIG. 7 schematically illustrates a relationship between the television apparatus 300 and time cloud service server 411 when the scene information function (Scenefo) is used. In this embodiment, a service connecting the video content and scene information is referred to as “Scenefo”.

Assume that the user is viewing a program and he or she finds a scene of interest. In this case, the user presses, for example, a “scene information key” of the remote controller (it is preferable at this time that the time cloud service button 108 of FIG. 4 has been turned ON). Alternatively, when an “interesting” button (“interesting” key) is displayed in area 104, the user clicks this key. Then, a scene information service application is activated. At the same time, a browser is activated. Then, the user can browse a tag list obtained by collecting interesting scenes as a plurality of tags or a scene list. There may be a case where there are a plurality of tag lists or a plurality of scene lists. In general, the tag list includes a plurality of tags for each program. The scene list may include scenes of one program and those of another. The tag list and scene list are included in the scene information. As described later, the scene information includes various information.

The tag list or scene list is created and uploaded to the time cloud service server 411 by a metadata creation company or a general user.

The tag list or scene list is section information obtained by cutting a scene in which, for example, a specific cast appears from a given program in units of several seconds or several tens of seconds. For identification of the section information, reproduction elapsed time (referred to as “relative time”) from a start position of the program is used, and a single scene is identified by a pair of start time of the scene and end time thereof.

The time cloud service server 411 refers to the scene information (program name, channel number, time location (referred to also as relative time from start position) of interesting scene on program) generated in response to “scene information key” operation to determine a corresponding tag or scene. The term “tag” refers to a single tag constituting the tag list. The tag list is generally created for each program. The term “scene” refers to a single scene constituting the scene list. The scene list can be created not only for a program that the user is viewing but also across a plurality of programs. Such a scene list can include a plurality of programs of the same or similar category.

A name or a comment that represents the program is added to the scene list. There may be a case where a plurality of types of scenes are created for each scene of one program. This is because the user's interesting scene may include landscape (background), a car appearing in the scene, or an actor driving the car. Thus, as the scene list, a scene list concerning the landscape, a scene list concerning the car, a scene list concerning the actor, and the like can be created.

As described above, when the user operates the “scene information key” with respect to a given scene in a program, scene information corresponding to the scene is sent from the time cloud service server 411 to the electronic apparatus. That is, the present apparatus has a means for displaying the viewing content and a list of the service menus associated with the content when receiving an instruction to activate the cloud service during reproduction of the content.

A plurality of scenes corresponding to the scene information are displayed on, for example, a right side of the screen 100. The user refers to the comment or name displayed together with each scene and operates the remote controller to select a desired scene and press the enter button. Then, on the screen 100, category selection buttons such as “product information”, “shop information”, “regional information”, “person information”, and “tag reproduction” related to the selected scene are displayed.

The display state of the screen 100 at this time can provide more detailed information concerning a product, a shop, a region, and a person appearing in the user's interesting scene, and “tag reproduction”. When the “tag reproduction” is selected, the tag can be reproduced. That is, the present apparatus has a means for switchably displaying the service menus depending on the display state.

When the user selects, for example, the “product information” button, the screen 100 can shift to a state of presenting an online shop of the product. This can be made because a URL of the online shop as extended link information is included, together with data of the scene list or tag list, in the scene information sent from the time cloud service server 411.

When the user selects, for example, the “shop information” button, the screen 100 can shift to a guide site of the shop appearing in the user's interesting scene. When the user selects the “regional information” button, the screen 100 can shift to a guide site of a tourist bureau, a local government office, or the like. In this case, the information sent from the time cloud service server 411 may include map information created based on GPS information. The user can determine whether or not the shop is located near his or her home by checking the map.

When the user selects the “person information” button, the screen 100 can shift to a guide site of another program or performance in which the actor corresponding to the person information appears, a fan club of the actor, or the like. The function of the “scene information key” may be realized using another key.

<Scene List Function (SceneList)>

FIG. 8 schematically illustrates a relationship between the television apparatus 300 and time cloud service server 411 when the scene list function (SceneList) is used. The scene list function has the same functional means as those in the scene information function (Scenefo).

For example, there may be a case where the user wants to view a goal scene or a scene in which a specific player appears in a football program. Moreover, there may be a case where the user wants to view a scene in which a specific wrestler (“sumo” [Japanese-style wrestling] wrestler) appears in a “sumo” program.

In such a case, the user who is viewing the program operates, for example, “scene list key” (it is preferable at this time that the time cloud service button 108 of FIG. 4 has been turned ON) of the remote controller. Then, the scene list function is activated to allow the user to access the scene list or tag list of the same or similar scenes as or to the scene that he or she wants to view.

In general, the tag list is created for each program. The scene list can be created not only for a program that the user is viewing but also across a plurality of programs. For example, a match-up of a specific wrestler is held once a day, and the programs corresponding to a plurality of days are recorded. That is, the scene list is created across a plurality of programs. A name or a comment that represents the program is added to the scene list. There may be a case where a plurality of types of scene lists or tag lists are created for each scene of one program. These scene lists or tag lists are provided also from the time cloud service server 411. That is, the present apparatus has a means for displaying the viewing content and a list of the service menus associated with the content when receiving an instruction to activate the cloud service during reproduction of the content.

When the user selects a desired scene list name and presses a reproduction button, a scene reproduction based on the selected scene list or tag list is started. The user can select a desired scene list name and presses, for example, the enter button. The pressing of the enter button causes scene cells constituting the scene list to be displayed in an array. The scene cells are arranged in chronological order. When the user moves the cursor to a desired scene cell and presses the reproduction button, scenes are reproduced in arrangement order of the scene cells, starting from a scene corresponding to the designated scene cell. That is, the present apparatus has a means for switchably displaying the service menus depending on the display state.

<Scene Play Function (ScenePlay)>

FIG. 9 schematically illustrates a relationship between the television apparatus 300 and time cloud service server 411 when the scene play function (ScenePLay) is used. The scene play function has also the same functional means as those in the scene information function (Scenefo).

For a long program, or a program that the user previously stopped viewing in the middle thereof, he or she may want to reproduce the program from the middle thereof. The user may also want to reproduce the program from his or her favorites scene. In such a case, the user clicks an operation button (guide image) of a “scene play” displayed in, for example, area 104 of the screen 100 (it is preferable at this time that the time cloud service button 108 of FIG. 4 has been turned ON). Then, layout of the images is changed, and a plurality of thumbnail images of representative recommended scenes are displayed in regard to the program currently being reproduced. For example, as illustrated on the right of FIG. 3, a plurality of thumbnail images of representative recommended scenes are displayed as the guide images. That is, the present apparatus has a means for displaying the viewing content and a list of the service menus associated with the content when receiving an instruction to activate the cloud service during reproduction of the content.

It should be noted that no guide image of the “scene play” is displayed on the screen 100 of FIGS. 1 to 3. However, when the user moves the cursor to any one of the guide images displayed in area 104 and operates a scroll key of the remote controller, various guide images can be displayed. Since there exists the guide image of the “scene play” among the guide images displayed, the user clicks this “scene play” guide image. Then, a plurality of thumbnail images of representative recommended scenes are displayed in regard to the program currently being reproduced.

The user operates the remote controller to select a desired thumbnail image using the cursor and presses the reproduction button, whereby reproduction of the program can be started from a scene represented by the thumbnail image. That is, the present apparatus has a means for switchably displaying the service menus depending on the display state.

The recommended scene is created and prepared by, for example, the time cloud service server 411. There are various methods of creating the recommended scene. The time cloud service server 411 collects, from many clients (users), interesting scene information and/or recommended data. Then, the time cloud service server 411 keeps statistics on program information of the interesting scene information and/or program information included in the recommended data. Based on the statistical processing, an order among a plurality of scenes that have been designated a number of times by the program information is determined for each program. Then, the scenes having higher orders within one program are set as representative scenes, and representative scene information corresponding to each repressive scene is created. As a result, a plurality of representative scenes are determined for each program. The representative scene information includes a name of the corresponding program, an air date/time thereof, and the relative time indicating a time elapsed from the start time of the program to the reproduction start time of the representative scene.

The time cloud service server 411 can receive information about a recording destination (hard disk drive, DVD, BD, etc.) of the program and recorded program information from the user's electronic apparatus and grasp which program is recorded in which recording medium. Thus, when creating the representative scenes, the television apparatus can read out the content including the representative scenes from the recording medium at high speed so as to present a plurality of representative scenes.

<Selection/Switching/Shifting of Scene Information Function (Scenefo), Scene List Function (SceneList), and Scene Play Function (ScenePlay)>

There may be a case (a) where after entering the scene information function (Scenefo), the user wants to shift to the scene list function (SceneList) or scene play function (ScenePlay). Alternatively, there may be a case (b) where after entering the scene list function (SceneList), the user wants to shift to the scene play function (ScenePlay) or scene information function (Scenefo). Further alternatively, there may be a case (c) where after entering the scene play function (ScenePlay), the user wants to shift to the scene list function (SceneList) or scene information function (Scenefo).

In order to cope with such cases, the present apparatus has a function switching function. Various methods are available for the function switching. For example, a configuration may be possible, in which the scene list or tag list is displayed and, then, the scene information key, a scene list key, and a scene play key are displayed so as to be selectable. Alternatively, the scene information key, scene list key, and scene play key may be provided in the remote controller, or on the display of the mobile terminal.

Alternatively, a scene-related function switching key may be provided. By repeatedly operating the scene-related function switching key, the scene information function (Scenefo), scene list function (SceneList), and scene play function (ScenePlay) can be switched one from one to another in a cyclic manner even any of the functions is running.

<Control Information Used when Scene Information Function (Scenefo), Scene List Function (SceneList), or Scene Play Function (ScenePlay) Runs>

The time cloud service server 411 can also transmit, to the electronic apparatus, control information for controlling a television function. The time cloud service server 411 has an information extended link function and can thus associate data transmitted from a database server managing metadata or many user with each other to thereby create extended link data. The time cloud service server 411 has an association table for data association. Various methods are available for data association. For example, various data can be associated with each other using a common identifier. In this case, sub identifiers can be added to the identifier so as to classify a degree of data association or type of the associated data.

As described above, it is possible to create scene information associating the program information, a shop, a product, and the like.

The extended link data may include a control signal for automatically controlling the television function. For example, the DTV functional block 14 of the television apparatus has a 3D signal processing module, a control signal for switching a content processing mode to a 3D processing mode can be transmitted. The DTV functional block 14 of the television apparatus can respond to the control signal. The 3D processing includes conversion of a 2D signal into a 3D signal. The 3D processing further includes supply of the 3D signal to a 3D display. The 3D display may be a display allowing the user to view a 3D image with the naked eye, or a display allowing the user to view a 3D image with specific glasses. When determining that a scene or a video to be viewed by the user is preferably displayed in a 3D mode and that the television apparatus has the 3D function, the time cloud service server 411 can transmit a control signal for automatically switching an operation mode of the television apparatus to a 3D processing state.

Moreover, an audio control signal or an audio signal corresponding to a given scene is transmitted from the time cloud service server 411 to the DTV functional block 14 of the television apparatus. In this case the DTV functional block 14 can respond to the audio control signal or audio signal. In particular, when the scene information function or scene list function runs, the television apparatus assumes a reproduction state different from a state where a normal program is continuously reproduced. Therefore, music (BGM, etc.) appropriated for a current scene or a sound is output by an audio system of the television apparatus.

Further, there may be a case where it is preferable to perform image brightness adjustment or image color adjustment, depending on a scene that the user views. Also, in such a case, the time cloud service server 411 can transmit the extended link data including data for image adjustment. For example, assume that the scene list is requested in a state where the electronic apparatus is logged in using the family login ID. Further, assume that a specific scene (extremely violent scene, etc.) exists among a plurality of scenes designated by the scene list. In such a case, the time cloud service server 411 may transmit, to the client, the extended link data including a control signal for skipping the specific scene.

The time cloud service server 411 can receive from the electronic apparatus, together with the login identifier, manufacturer information of the television apparatus or mobile terminal and specification information including display capability and store them. This is because that the display capability, control method, or the like may differ depending on the manufacturer. When transmitting the control signal to the electronic apparatus (client) while the scene information function (Scenefo), scene list function (SceneList), or scene play function (ScenePlay) runs, the time cloud service server 411 can transmit a control signal complying with the client. Moreover, when display data such as a message created by the time cloud service server 411 is transmitted, a language or a voice of the message may be changed (between, for example, Japanese, English, French, Korean, Chinese, German, and Spanish) depending on a setting of the electronic apparatus (client).

Moreover, when the television apparatus including the electronic apparatus (client) has a power-saving function, the time cloud service server 411 is configured to transmit a power-saving instruction or a cooperation request signal for power-saving. The time cloud service server 411 can receive a power demand state and power demand forecast information from, for example, an electric power company. When power consumption (demand) is close to a power supply amount, the time cloud service server 411 can ask each electronic apparatus for cooperation for power-saving.

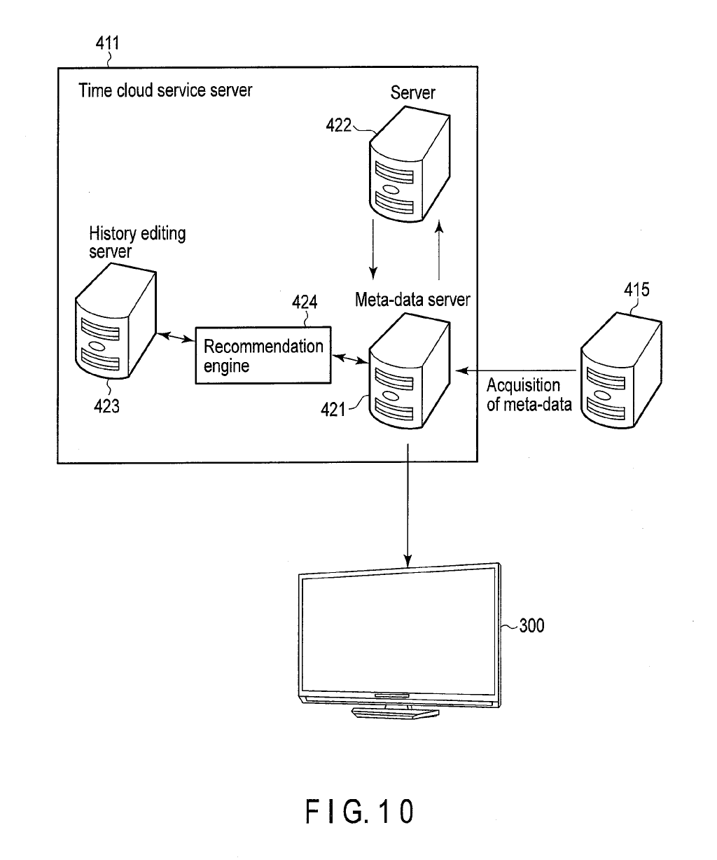

FIG. 10 illustrates an example of servers constituting the time cloud service server 411.

A reference numeral 421 denotes a metadata server, which can receive various metadata from a data creation server 415 of an external data creation company. The metadata is program information and includes many types of information concerning the program such as a broadcast channel, an air date/time, and casts. The metadata server 421 uses the metadata to create the scene information, tag list, scene list, and the like. Further, there exist control information associated with the tag list, scene list, and scene information.

The metadata server 421 can register the tag list and/or scene list in a server 422 for tag list creation. Moreover, the metadata server 421 can acquire the tag list and/or scene list from the server 422 for tag list creation in response to a request from the client (electronic apparatus) and provide the acquired tag list and/or scene list to the client as the request source. The metadata server 421 can create the scene information by using the meta data and transmit the created scene information to the client (electronic apparatus).

The metadata server 421 collects, for example, the interesting scene information and recommended data from many clients (users) and transfers them to a history collection server 423. The history collection server 423 maintains statistics on the program information of the interesting scene information and/or program information included in the recommended data. Based on the statistical processing, an order among a plurality of scenes that have been designated a number of times by the program information is determined for each program. Then, the scenes having higher orders within one program are set as representative scenes, and representative scene information corresponding to each repressive scene is created. As a result, a plurality of representative scenes are determined for each program. The representative scene information includes a name of the corresponding program, an air date/time thereof, and the relative time indicating a time elapsed from the start time of the program to the reproduction start time of the representative scene.

When receiving a scene play request from the client, the metadata server 421 can acquire the representative scene information concerning the request program from the server 423 and transmits the acquired representative scene information to the client as a reply.

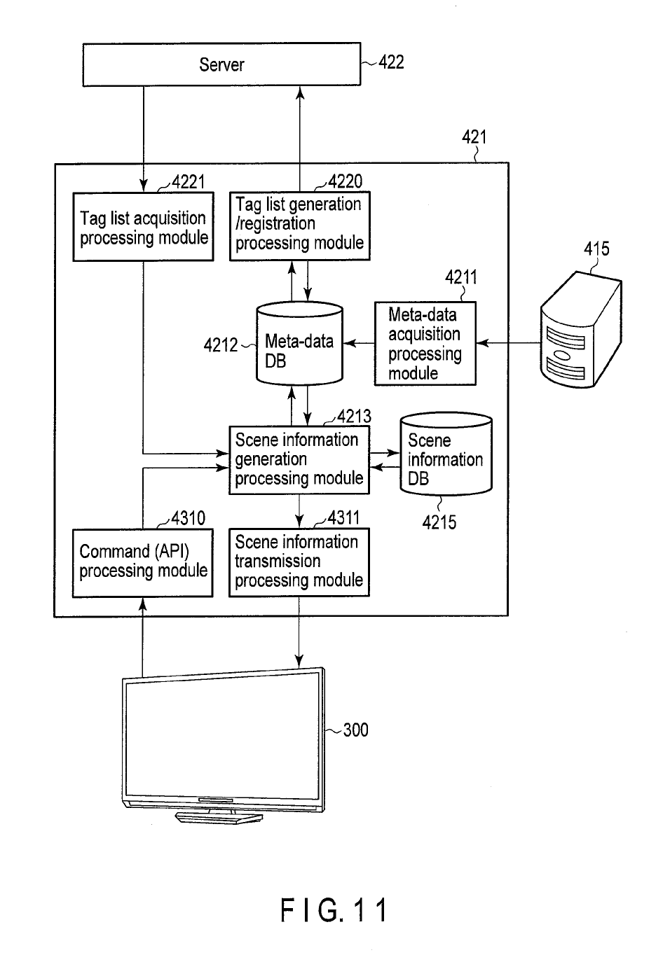

FIG. 11 illustrates an internal configuration of the metadata server 421. A metadata acquisition processing module 4211 receives various metadata from the data creation server 415 and stores the metadata in a database unit 4212. A tag list generation/registration processing module 4220 uses the metadata to generate the tag list and registers the generated tag list in the server 422. A tag list acquisition processing module 4221 can acquire the tag list from the server 422 for tag list creation in response to a request from the client (electronic apparatus) and provide the tag list to the client (electronic apparatus). A scene information generation processing module 4213 uses the metadata to create the scene information and stores the created scene information in scene information database unit 4215. An information transmission processing module 4311 transmits, in response to a request from the client, the scene information, tag list, and/or scene list to the client.

A command processing module 4310 receives an instruction or information from the client and reflects it in the operation of the metadata server 421. The above-mentioned blocks are representative ones. The database unit 4212 can store therein various data other than those described above. Moreover, various blocks exist as control blocks and achieve the operation to be described later.

The metadata server 421 described above performs information extended link processing. For example, as described above, when scene information of the interesting scene is transmitted from the client (user or electronic apparatus) to the metadata server 421, the metadata server 421 can transmit the extended link data described above together with data corresponding to a request from the client. Thus, the user can effectively use the extended link data.

FIG. 12 illustrates configuration examples of the electronic apparatus 222 and DTV functional block 14 together with a mutual relationship between the apparatus 222 and the block 14. The integrated controller 241 includes a DTV control module 2411, a login identifier management module 2412, a communication data management module 2413, and a login identifier transmission module 2414. The DTV control module 2411 controls the DTV functional module 14 based on user operation or based on the control data from the cloud service server 411. The login identifier management module 2412 controls storage of the login identifier when the login identifier described in FIGS. 3 and 4 is input and manages the login identifiers for both family use and individual use as table data. The communication data management module 2413 manages communication data for each login identifier. For example, when a logged-in user accesses an external server, the communication data management module 2413 manages corresponding history data. The history data includes also an access destination address, transaction data, and the like. Moreover, the communication data management module 2413 executes classification/storage processing for data transmitted from the cloud service server 412 and can use the data as display data. Data concerning the recording reservation, recording history, viewing reservation, and viewing history are managed by the login identifiers for both family use and individual use.

The login identifier transmission module 2414 transmits a logged-in login identifier to the cloud service server 412. The cloud service server 412 manages the login identifiers from many users and uses them to provide the guide image as described in FIG. 4.

The view controller 242 includes a demonstration image controller 2421 and a guide image controller 2422. With this configuration, it is possible to provide the demonstration image and guide image described in FIGS. 1 to 4 to the DTV side.

The DTV functional block 14 includes a one-segment reception/processing module 141 for receiving a signal from an antenna and a reception module 142 for receiving satellite broadcasting and digital terrestrial broadcasting, and a demodulation module 143. The reception module 142 and demodulation module 143 each include a plurality of tuners and can thus receive and demodulate broadcast programs of a plurality of channels simultaneously. A plurality of demodulated program signals can be converted into a DVD format in a DVD device 14A so as to be recorded on a digital versatile disk. Alternatively, the demodulated program signals can be converted into a BD format in a BD device 14B so as to be recorded on a Blu-ray® disk. Further alternatively, the demodulated program signals can be recorded, in the form of an arbitrary stream, on a hard disk of a hard disk drive 14C. The DVD device 14A, BD device 14B, and hard disk drive 14C are connected to the DTV functional block 14 through a home network connection module 148. The hard disk drive 14C may be a type that is connected to the home network connection module 148 by a USB cable. The hard disk drive 14C may be a type that can simultaneously record all the programs of for example, set six channels for about one to three weeks. A function of this sort may be referred to as “time shift function”. The hard disk drive may be configured to be extendable.

The network-connected device and recorded program information are grasped by a television controller 140 and can be transmitted to the cloud service server 412 through the electronic apparatus. In this case, the cloud service server 412 can grasp the network-connected device and recorded program information in user's home. Thus, when various scenes are reproduced based on the scene list information, the cloud service server 412 can designate even the connection device in the home in which the various scene are recorded.

The program signal demodulated in the DTV functional block 14 or program signal reproduced from a recording medium such as DVD, BD, or hard disk (HD) is subjected to various adjustments (brightness adjustment, color adjustment, etc.) in a signal processing module and is then displayed on the screen 100 of the display through an output module 145.

The DTV functional block 14 includes a power supply circuit 146. The power supply circuit 146 can freely switch an operating state between a state where a battery 147 is used and a state where a commercial power supply is used. The switching of the power supply use state can be forcibly made by a user's remote controller operation or can be automatically made based on external information.

The cloud service server 411 can transmit a control signal for automatically switching an operation mode of the television apparatus to a 3D processing state. Moreover, the cloud service server 411 can transmit an audio control signal or an audio signal corresponding to a given scene to the television apparatus. Moreover, the time cloud service server 411 can transmit the extended link data including data for image adjustment.

The DTV functional block 14 includes a near-field transceiver module 149. Data exchange with the mobile terminal can be achieved through the near-field transceiver module 149. The mobile terminal can request the DTV functional block 14 for an operation image. When receiving the request for the operation image, the DTV functional block 14 can transmit the guide image as illustrated in FIGS. 3 and 4 to the mobile terminal. The user can control the electronic apparatus by using the guide image displayed on the mobile terminal.

The DTV functional block 14 can check the control data transmitted from the cloud service server 412 to automatically reflect the control data in its operation state.

Thus, according to the system described above, basically, in response to a user's first operation signal, the electronic apparatus transmits trigger data (control signals corresponding to the scene information key, scene list key, and scene play key) to the server through the network connection module. Then, the electronic apparatus acquires the extended link data sent back based on the trigger data and separately stores a first control signal (instruction) for automatic control and a second control signal (instruction) responding to a user's second operation signal. The above first and second control signals are stored in the integrated controller or model. The electronic apparatus can perform autonomous operation based on the first control signal (instruction) and/or perform non-autonomous operation based on the second control signal (instruction). The autonomous operation refers to automatic operation. As illustrated in, for example, FIG. 4, acquisition of the display image in area 106 and control of the DTV functional block 14 are performed under the autonomous operation. The non-autonomous operation refers to operation made in response to the second operation signal input from the user. The non-autonomous operation corresponds to, for example, operation responding to product selection, operation responding to tag list selection, operation responding to scene list selection as described in FIGS. 6, 7, and 8. The extended link data includes display data to be displayed. The display data includes various messages, an album, and the like. When a power-saving instruction is sent from the time cloud service server 411, the DTV functional block 14 can execute power-saving operation. The power-saving operation is achieved by, for example, switching from full-segment reception state to one-segment reception state, reduction of a display area of the display, or switching from commercial power mode to battery mode.

On the screen illustrated in FIGS. 1 to 4, the DTV functional block 14 can perform control so as to make an area of a video image in area 101 brighter than the other areas. That is, the guide images in areas 102 to 104 can be made darker than the video image in area 101 so as to make the video image more visible. However, the guide image pointed to by the cursor for some purpose can be made brighter.

The present apparatus can effectively utilize a calendar. The following describes a display mode of the calendar and calendar utilization means and method.

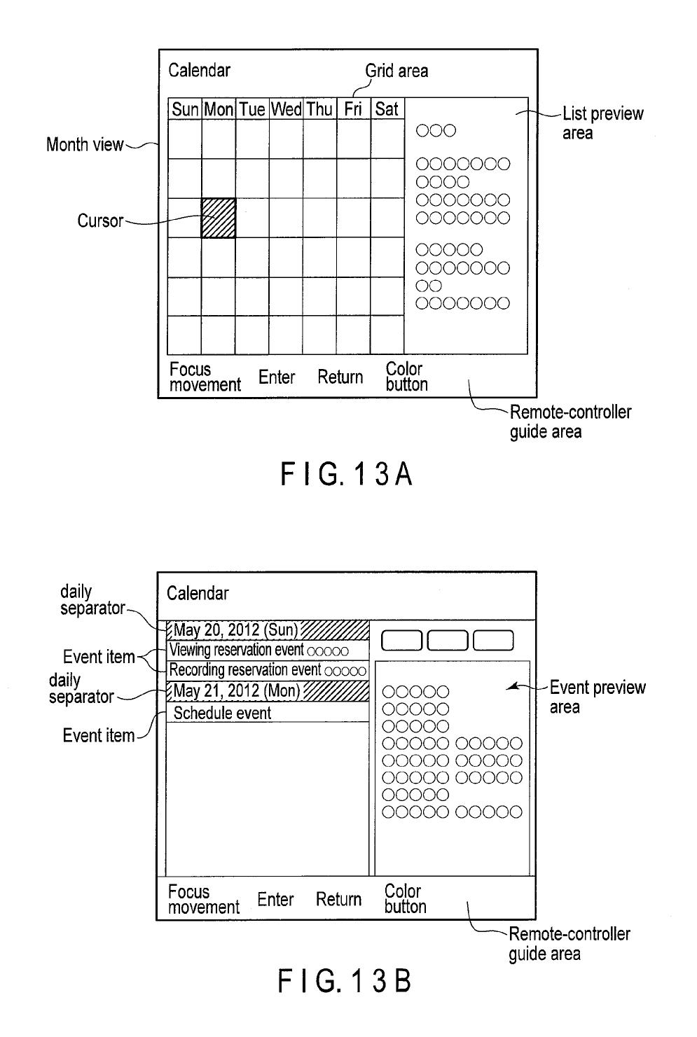

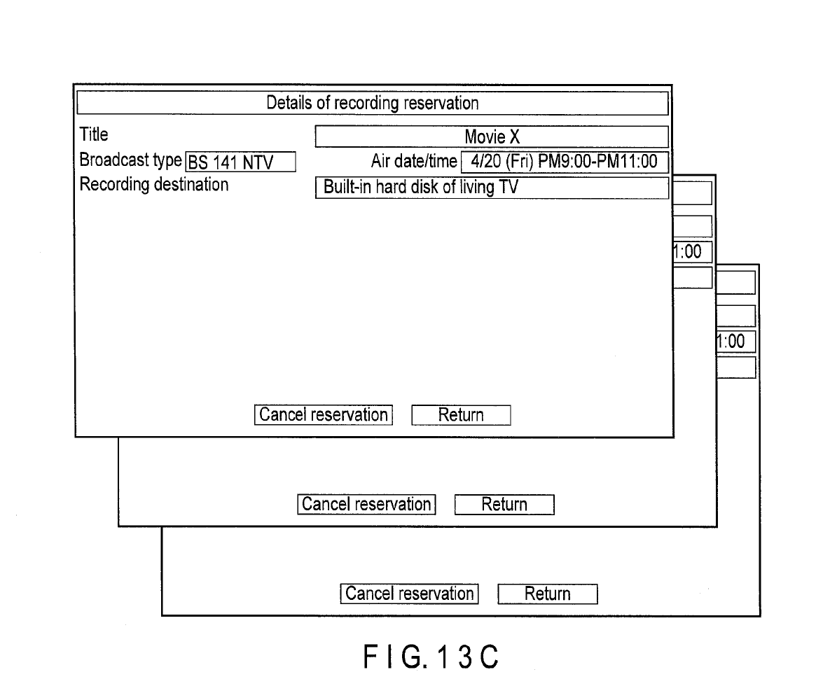

FIG. 13A is an example in which a monthly calendar is displayed. The calendar includes a plurality of areas, to which names are given, respectively, as illustrated. The entire image is referred to as month view, a display area of a plurality of weeks is referred to as month grid area, and a list preview area is disposed on a right side of the image. Moreover, a remote-controller guide area is disposed on a lower side of the image. The display state as illustrated in FIG. 13A is obtained by moving the cursor to the region 103 of FIG. 4 and clicking it (or pressing the enter button).

FIG. 13B is an image obtained by moving the cursor to a position as illustrated in FIG. 13A and presses the enter button. The image of FIG. 13B represents an event list corresponding to a specified date. Moreover, an event list of the next day following the specified date can be displayed. Also in this image, names are given to a plurality of areas, respectively, as illustrated. The image roughly includes a list area and an event preview area. The list area includes a daily separator and an area referred to as “event item”. Examples of the event item include “viewing reservation event”, “recording reservation event”, and “schedule event”. By moving the cursor to the event item, a preview of the corresponding event item can be viewed in the event preview area.

FIG. 13C is an image representing details of the event. The image of FIG. 13C is displayed by selecting the event item of FIG. 13B using the cursor and pressing the enter button. A frontmost image represents an example in which details of the “recording reservation event” are displayed. In this image, “title” of the recording reserved program, “broadcast type” thereof, “air date/time” thereof, “recording destination medium” thereof, and the like are displayed.

When a “return” button of the image of FIG. 13C is selected and the “enter” button is pressed, the image displayed on the display is switched to the image of FIG. 13B. When a “return” button of the image of FIG. 13B is selected and the “enter” button is pressed, the image displayed on the display is switched to the image of FIG. 13A.

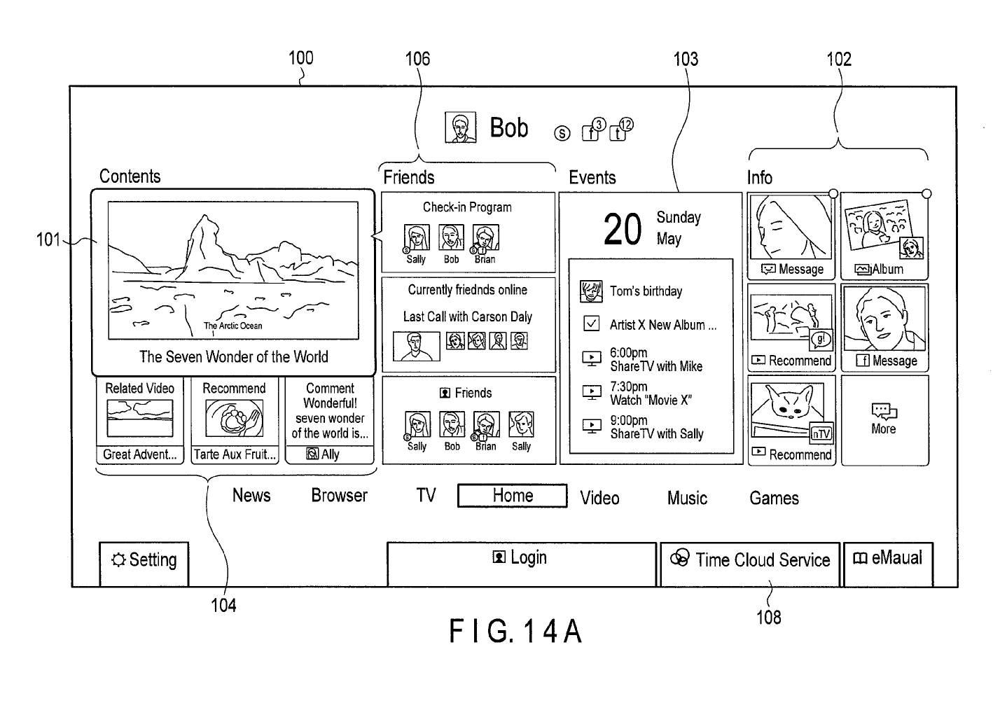

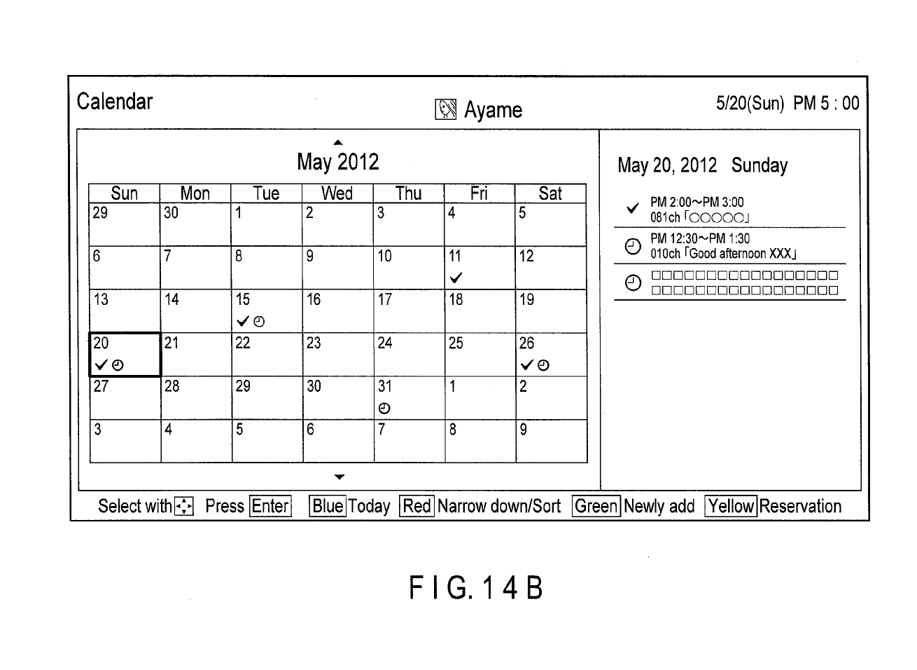

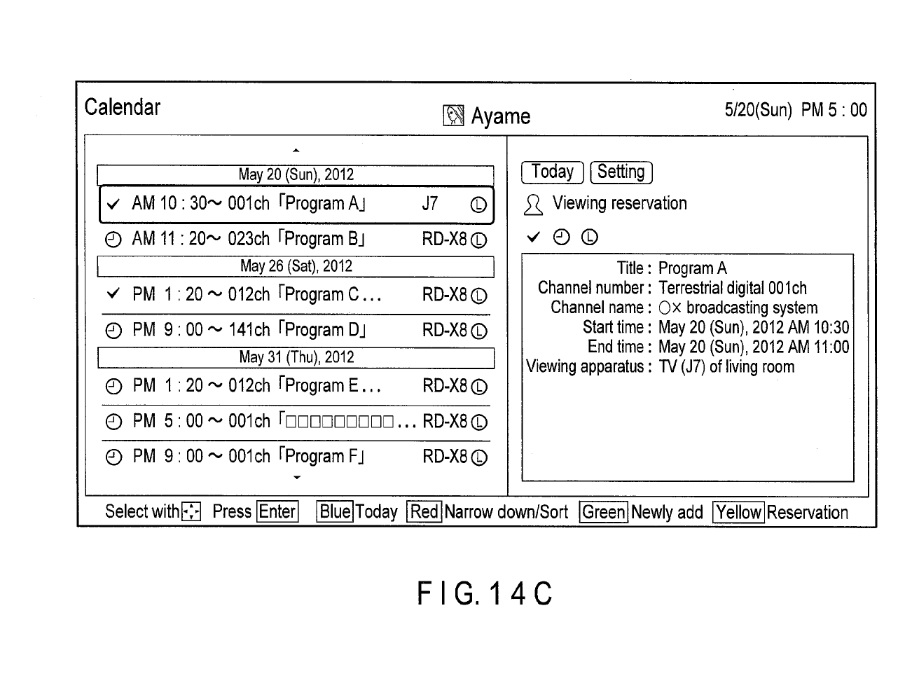

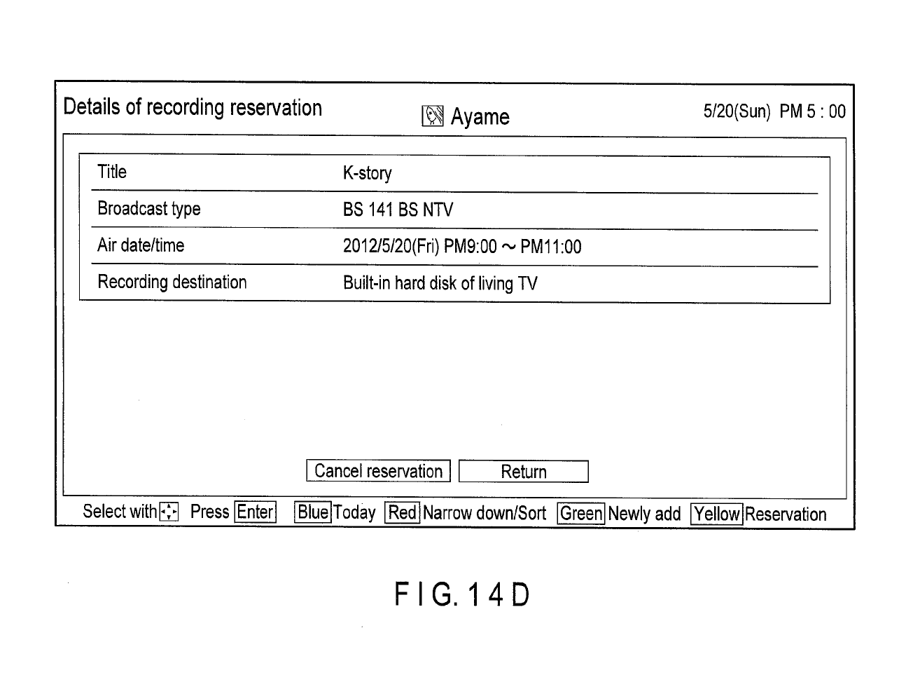

FIGS. 14A to 14D concretely illustrate a change in the above image. FIG. 14A illustrates the same image (“Home” image) as that of FIG. 4. When area 103 of FIG. 14A is selected using the cursor and the “enter” button is pressed, the image displayed on the display is switched to the image of FIG. 14B (corresponding to the state of FIG. 13A). FIGS. 14C and 14D correspond to FIGS. 13B and 13C, respectively.

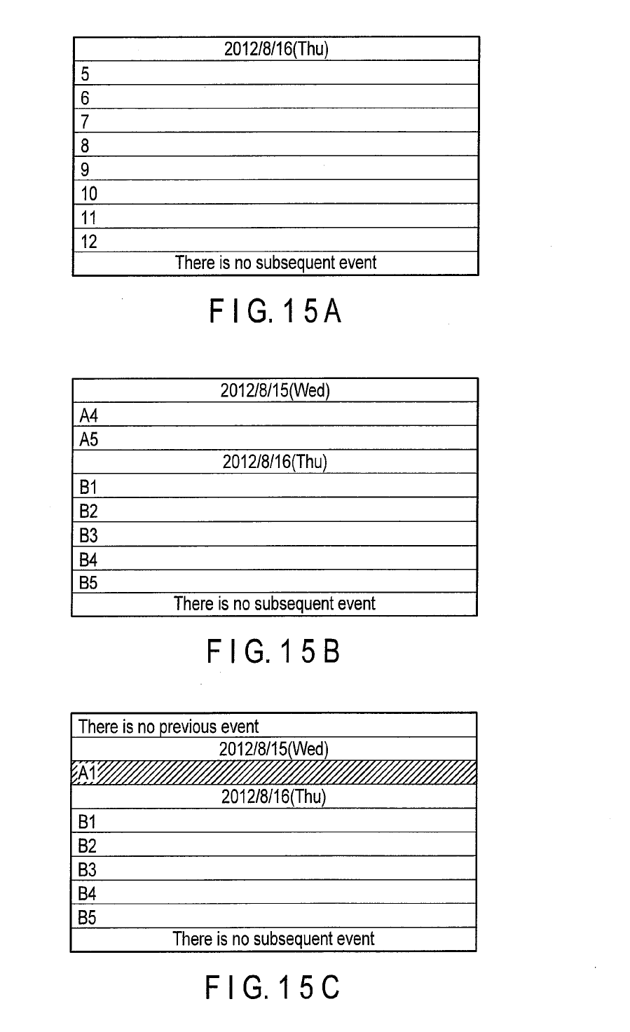

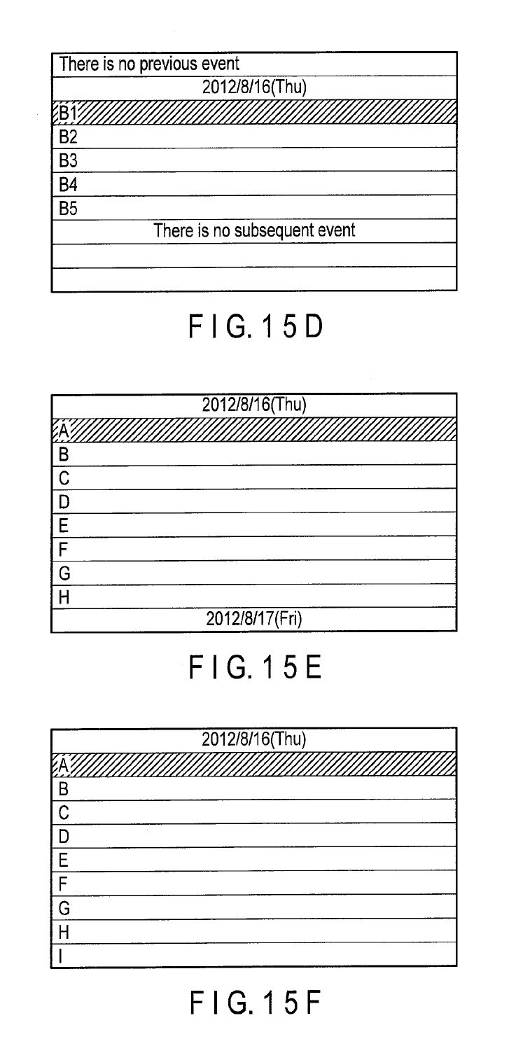

FIGS. 15A to 15F are views each illustrating a state of image when a scroll controller realized by the view controller or television controller is operated.

Hereinafter, a display method will be described by classifying a display state into a plurality of patterns depending on a registration state of a reservation event, with an assumption that the maximum number of displayable rows in the list area is set to 10 (including the daily separator). The maximum number of displayable events is 9 excluding the daily separator and, when there exists a message separator (for example, message separator saying “there is no subsequent event”), the maximum number of displayable events is set to 8.

FIG. 15A is a pattern 1. This example represents that 12 (1 to 12) events are registered on August 16, and there is no reserved event in August 17 and subsequent days. This display state can be obtained by selecting August 17 or any subsequent day in the month view to cause the display state to shift to the list display image.

FIG. 15B is a pattern 2. This example represents that five (A1 to A5) events are registered on August 15, five (B1 to B5) events are registered on August 16, and there is no registered event in August 17 and subsequent days. This display state can be obtained by selecting August 17 or any subsequent day in the month view to cause the display state to shift to the list view.

FIG. 15C is a pattern 3. This example represents that there is no registered event in August 14 and previous days, one (A1) event is registered on August 15, five (B1 to B5) events are registered on August 16, and there is no registered event in August 17 and subsequent days. This display state can be obtained by selecting August 17 or any subsequent day in the month view to cause the display state to shift to the list view.

FIG. 15D is a pattern 4. This example represents that there is no registered event in August 15 and previous days, five (B1 to B5) events are registered on August 16, and there is no registered event in August 17 and subsequent days. This display state can be obtained by selecting August 17 or any subsequent day in the month view to cause the display state to shift to the list view.

FIG. 15E is a pattern 5. This example represents that there is no registered event in August 15 and previous days, eight (A to H) events are registered on August 16, and there is any registered event in August 17. This display state can be obtained by selecting August 16 in the month view to cause the display state to shift to the list view. There may be a case where only the daily separator is displayed on the lowermost row, depending on the number of reserved events to be displayed in the event list area as illustrated in FIG. 15E.

FIG. 15F is an example in which today is August 16, and 12 events (A to I) are registered on August 16. Such an image can be obtained by pressing a “Today” button. A case where there is no event today and subsequent days and the like conform to the pattern 1 to 5.

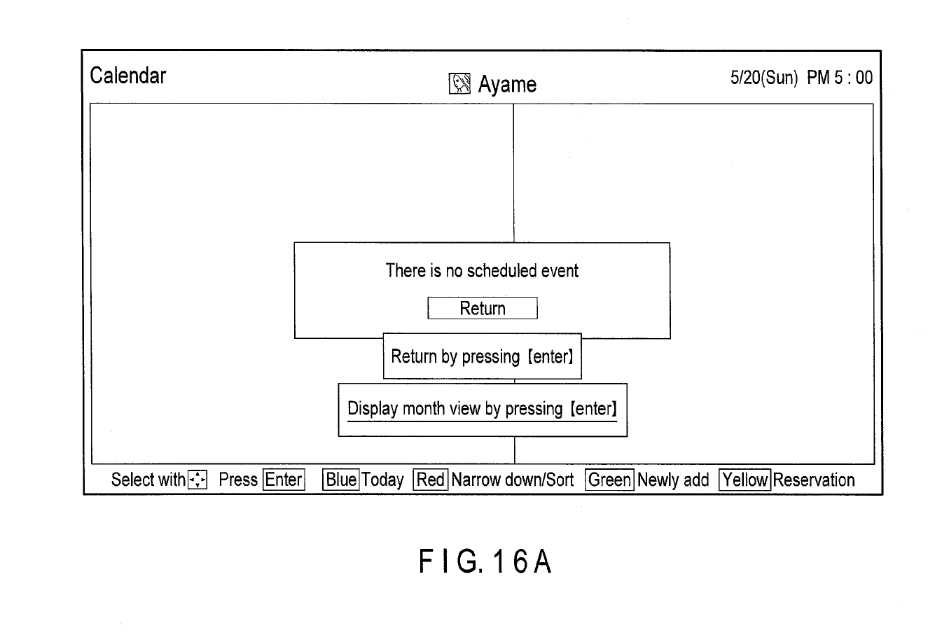

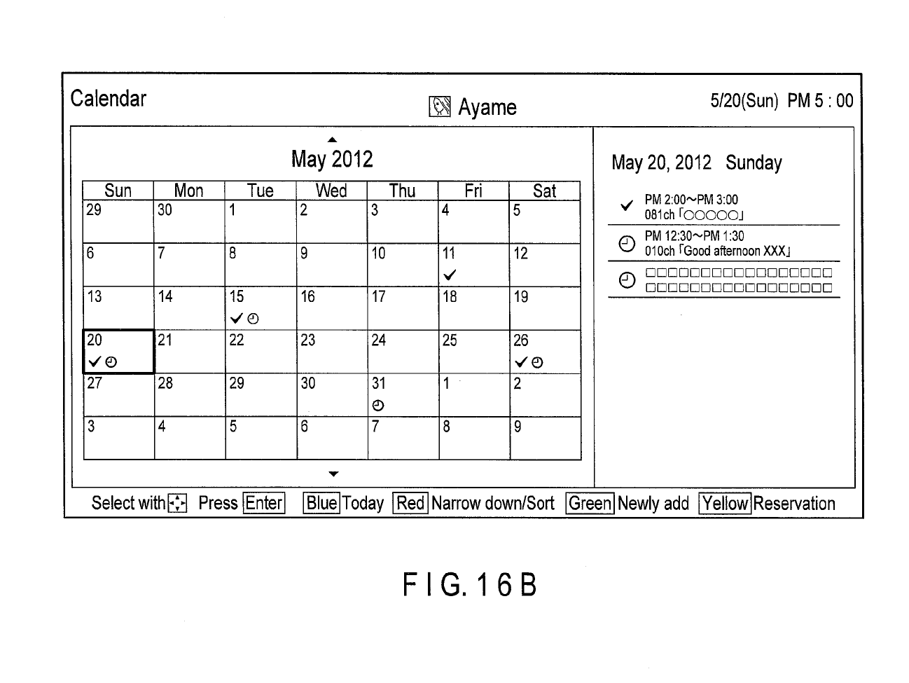

FIG. 16A illustrates an example of an image to be displayed when a given day is selected when no event is registered in the month view. In this image, message dialogs saying “there is no scheduled event” “return by pressing “enter” button”, “Display month view by pressing “enter” button”, and the like pop up. When the “enter” button is pressed, the month view image in which a focus is placed on the grid of today appears as illustrated in FIG. 16B.

As described above, display of calendar-related information can be described as follows. The event items are grouped by the daily separator on a day-to-day basis. In this example, no focus is placed on the daily separator. When there is any event item, the daily separator is always displayed in the topmost row of the list area. Following the daily separator, summaries of the event items set in the designated day are displayed. The event items are arranged in chronological order from top (past) to bottom (future). When a focus is placed on a given event item, detailed information of the corresponding event item is displayed in the event preview area. The displayed even items can be filtered or sorted according to conditions.

The scroll of the event item list can be described as follows. The list can not only display the event items of one day but also scrolled up and down across over some consecutive days. The focus to be placed on the event item list can be moved using cursor-up and cursor-down keys (an upward arrow and a downward arrow). The focus cannot be placed on the daily separator. Operating a page-up/page-down button causes the display image to shift to next page (not to next item), and a focus is placed on the topmost item. Pressing the cursor-up key (upward arrow) in this state causes the display image to shift to the previous page (not to the previous item), and a focus is placed on the bottommost item. Pressing the cursor-down key (downward arrow) in this state causes the display image to shift to the next page (not to the next item), and a focus is placed on the topmost item.

The focus can be moved between the list area and function buttons as follows. When a cursor-left key (leftward arrow) is pressed in a state where a focus is placed on the event item, the focus is moved to the “today” button. When a cursor-right key (rightward arrow) is pressed in a state where the focus is placed on the “today” button, the focus is moved to the event item. The focus cannot be moved between the list area and event preview area using the cursor-left and cursor-right keys (leftward arrow, rightward arrow). The focus movement by the cursor-left and cursor-right keys need not be cyclic.

The switching from the list view to the month view is not limited to the above embodiment. For example, the list view may be switched to the month view by placing the focus on the daily separator using the cursor and pressing the enter button. Meanwhile, the switching from the month view to the list view may be achieved by selecting one block of the calendar in the month view and pressing the enter button.

The display state of the calendar can be switched from one to another by a scroll function described below.

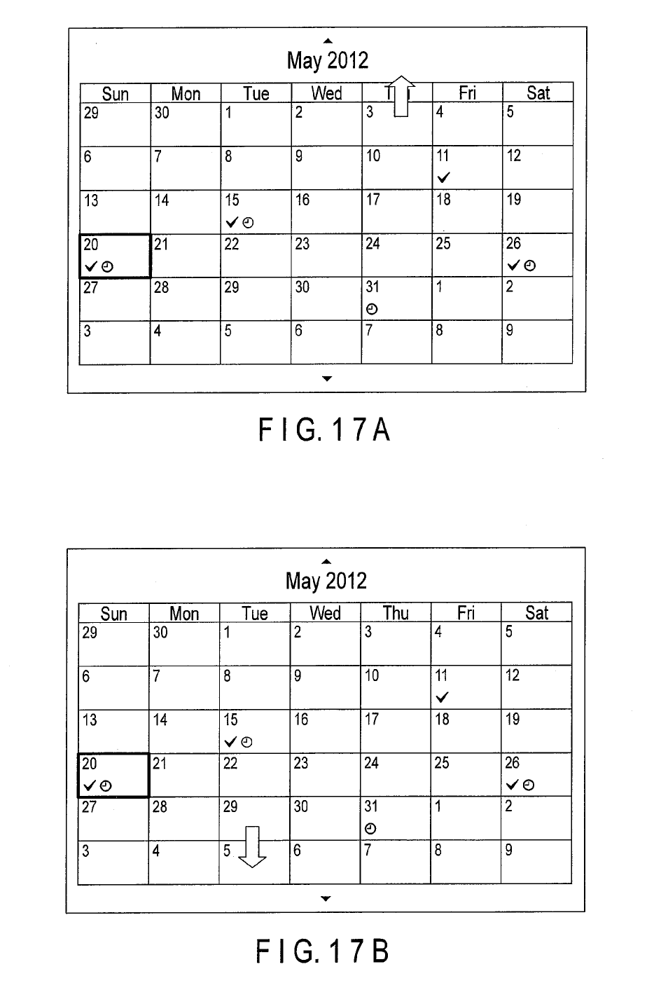

As illustrated in FIG. 17A, when the cursor-up key (upward arrow) of the remote controller is pressed in a state where a focus is placed on, for example, May 3 (Thu), a calendar of April is displayed, and a focus can be placed on April 26 (Thu) (Thursday of the last week in April).

As illustrated in FIG. 17B, when the cursor-down key (downward arrow) of the remote controller is pressed in a state where a focus is placed on, for example, May 29 (Tue), a calendar of June is displayed, and a focus can be placed on June 5 (Tue) (Tuesday of the first week in June).

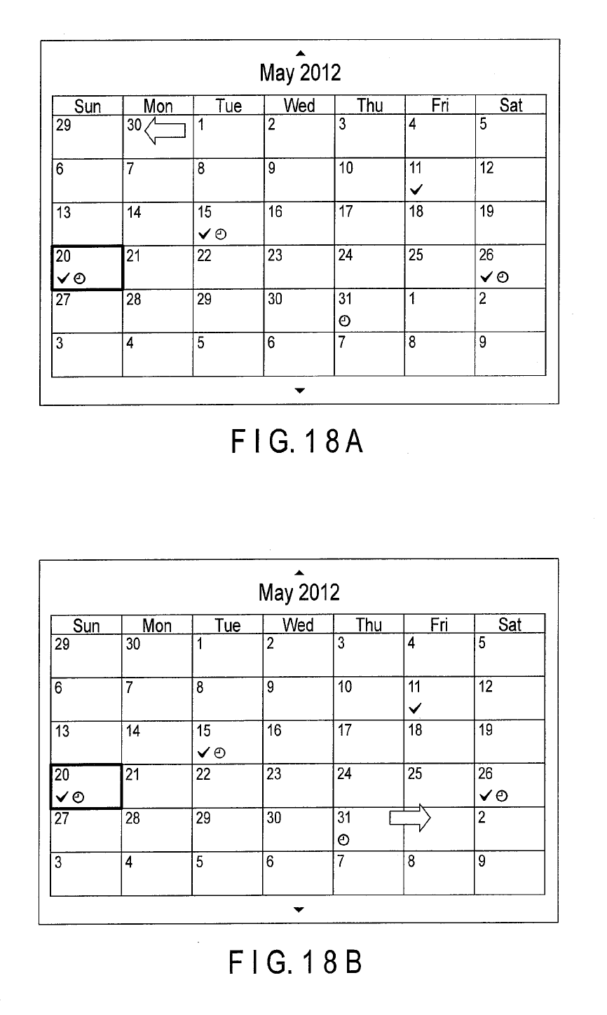

As illustrated in FIG. 18A, when the cursor-left key (leftward arrow) is pressed in a state where a focus is placed on, for example, May 1 (Tue), a calendar of April is displayed, and a focus can be placed on April 30 (Mon) (last day in April).

As illustrated in FIG. 18B, when the cursor-right key (rightward arrow) is pressed in a state where a focus is placed on, for example, May 31 (Thu), a calendar of June is displayed, and a focus can be placed on June 1 (Fri) (first day in June).

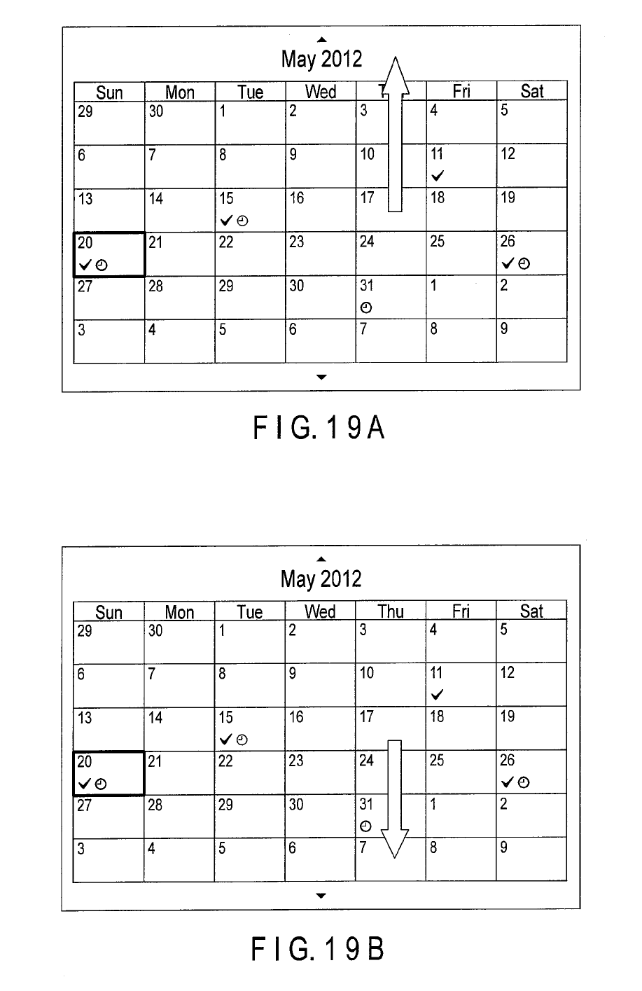

As illustrated in FIG. 19A, when an up-page button is pressed in a state where a focus is placed on, for example, May 17 (Thu), a calendar of April is displayed, and a focus can be placed on April 17 (Thu) (same day in April).

As illustrated in FIG. 19B, when an down-page button is pressed in a state where a focus is placed on, for example, May 17 (Thu), a calendar of June is displayed, and a focus can be placed on June 17 (Sun) (same day in June).

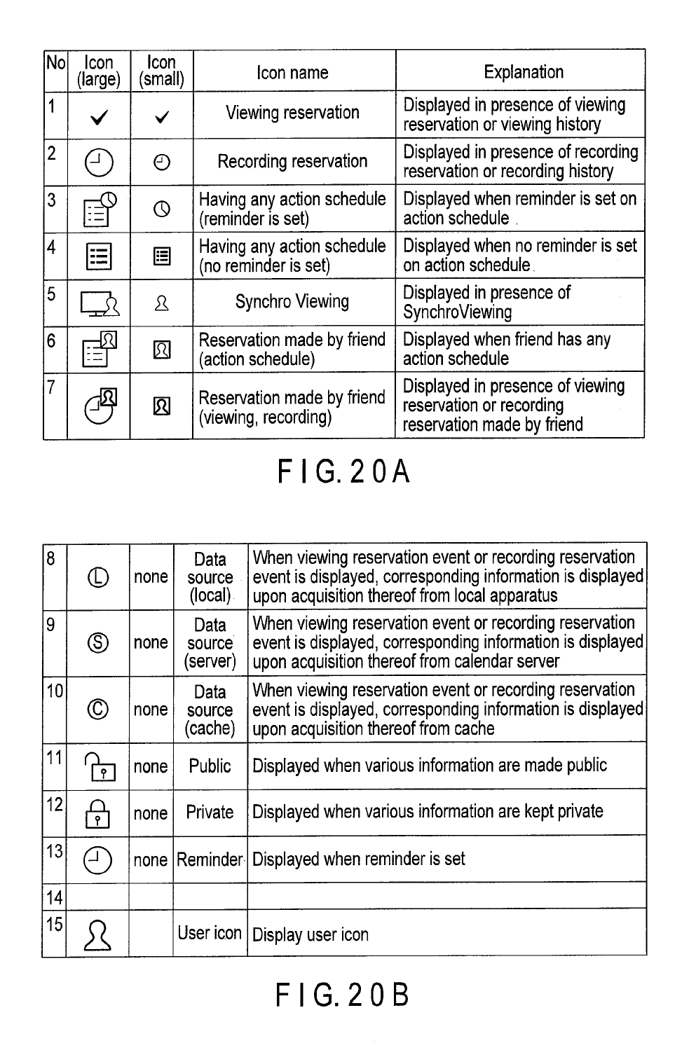

FIGS. 20A and 20B are tables listing a name and meaning of each icon to be displayed in the calendar image. By displaying such icons in the calendar, the user can quickly grasp the scheduled events of the day.

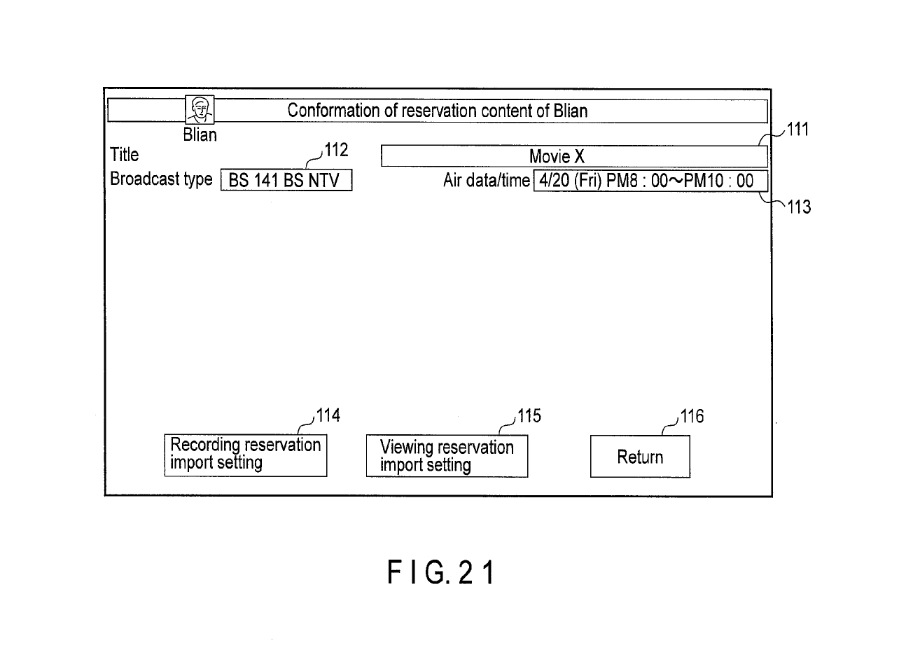

Various icons may be used in addition to those listed in the tables of FIGS. 20 and 21. For example, a time table at school may be represented by the icon (for example, as an image of textbook). Moreover, the icon may freely selected and set by the user. In this case, many kinds of icons may be previously stored in a memory so as to be selectable by the user.

Information in the above calendar such as action schedule can be edited (modification, addition, movement, deletion, etc.) in an editing mode.

Information such as the recording reservation, recording history, viewing reservation, and viewing history can be utilized on the month view or list view of the calendar.

It is possible to shift the display state from the month view or list view of the calendar to a preview of a program included in the viewing history or recording history, reproduction of the scene list, or reproduction of the tag list. That is, the cursor is moved to a desired day in the month view of the calendar to place a focus thereon and, in this state, a viewing history button or a recording history button of the remote controller can be operated. When the viewing history button or recording history button is operated, a list of programs viewed or recorded in the corresponding day can be displayed. Then, moving the cursor to a desired program to place a focus thereon allows a preview of the corresponding program to be displayed.

Moreover, it is possible to confirm the recording reservation or viewing reservation on the month view or list view of the calendar.

In the present apparatus, it is possible to combine additional information of one user (present user: user who is operating the present apparatus) and additional information of another user. The calendar added with the additional information may be referred to as “information calendar” or “control calendar”.

In the present apparatus, it is possible for the present user to confirm recording reservation information or viewing reservation information of the another user and to import it as the additional information for the present user. The recording reservation information and/or viewing reservation information of the another user are, for example, information added to the calendar of the another user.

The recording reservation information and/or viewing reservation information of the another user may be recording reservation information and/or viewing reservation information in the calendar or database managed by the another user or may be recording reservation information and/or viewing reservation information in the calendar or database managed in another apparatus.

FIG. 21 illustrates an image to be displayed when the recording reservation information and viewing reservation information of the another user are imported as information to be managed in the calendar of the present user. The image of FIG. 21 can be obtained by clicking, for example, an “another user's reservation information” button corresponding to a desired day on the list view of the calendar. In FIG. 21, reservation content of the another user (Brian) is displayed. When this area is selected using the cursor to operate, for example, a “next key”, reservation information of still another user can be displayed.

On the image of FIG. 21, a program title is displayed in an area 111, and broadcast type is displayed in an area 112. Moreover, air date/time of the program is displayed in an area 113, a button for designating whether or not to import the recording reservation information is displayed in an area 114, and a button for designating whether or not to import the viewing reservation information is displayed in an area 114. A return button is displayed in an area 116. When the return button is selected using the cursor, followed by pressing of the enter button, the image shifts to the list view displayed immediately before. When area 112 is selected using the cursor to operate, for example, the “next key”, a reservation state of another program can be confirmed.

One of areas 114 and 115 can be selected by the cursor. The area that is not selectable is made darker. Assume that area 114 is selectable by the cursor in the example of FIG. 21. In this case, when the present user selects this area 114 and presses the enter button, it is possible for the present user to import a program for which recording is reserved by the another user (Brian) as his or her own (present user's) event. Assume that area 115 is selectable by the cursor in the example of FIG. 21. In this case, when the present user selects this area 115 and presses the enter button, it is possible for the present user to import a program for which viewing is reserved by the another user (Brian) as his or her own (present user's) event.

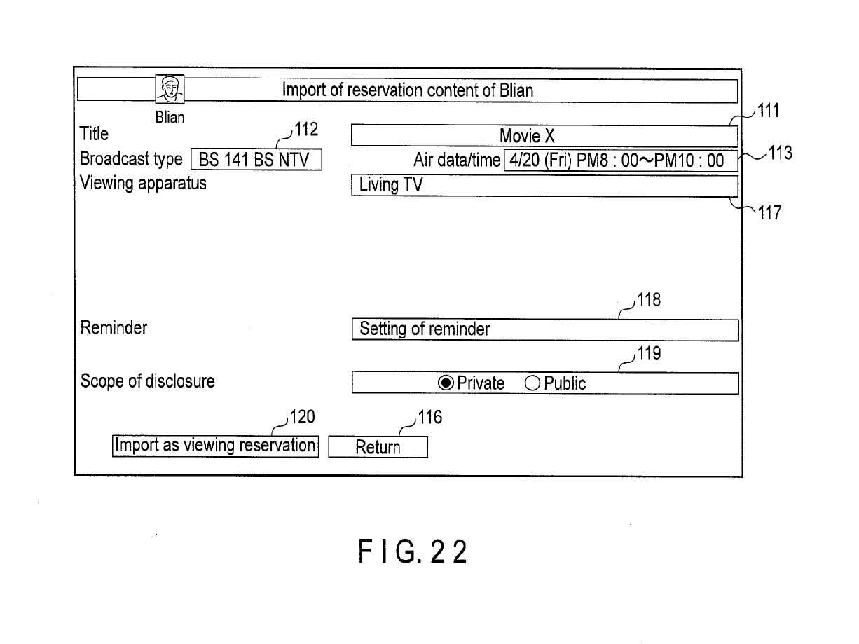

The buttons of areas 114 and 115 in the image of FIG. 21 may be used for shifting the current image to a next image. For example, when area 115 is selected using the cursor, followed by pressing of the enter button, the image of FIG. 21 may shift to an image of FIG. 22 so as to allow the reservation information to be imported actually. In the image of FIG. 22, a button saying “import as viewing reservation” is displayed in an area 120. On the image of FIG. 21, when area 114 is selected using the cursor, followed by pressing of the enter button, the image shifts to the image of FIG. 22, where a button saying “import as recording reservation” is displayed in area 120.

Moreover, in the image of FIG. 22, an apparatus to be used for viewing can be designated in an area 117. That is, there may be a case where network-connected television apparatuses are installed in a living-room, a kitchen, a bedroom, and the like in a user's home. Under such circumstances, a viewing location and a viewing time can be designated. Moreover, the image of FIG. 22 indicates that viewing of a designated program will be started on a television apparatus in a living-room at a designated time.

Although the above example is an image displayed for importing information for the viewing reservation, the image used in the present apparatus is not limited to such a purpose. On the image where the viewing reservation is made, the viewing location can be designated at the same time.

Moreover, whether or not to set a reminder can be set in an area 118. When the reminder is set, a message saying, for example, “viewing reservation of program AAA has been set” is displayed on a lower side of the image, for example, three minutes before reproduction time of a designated program.

The above examples describe that it is possible to utilize, in the television apparatus that the present user him or herself uses, information such as the recording reservation, recording history, viewing reservation, and viewing history stored in his or her television apparatus, or another television apparatus in his or her home. In addition, the present television apparatus can communicate with the cloud service server. Therefore, information such as the recording reservation, recording history, viewing reservation, and viewing history uploaded and published on the cloud service server can be imported to the present television apparatus and utilized therein.

In this case, the program information needs to be processed to program information that can be used by the user. The reason that the processing is performed is that a broadcast program may differ in channel number, air date/time, and the like from one region to another. Therefore, the program information (for example, channel number and air date/time, and the like) of the recording reservation, recording history, viewing reservation, and viewing history created in a television apparatus of the another user needs to be processing for use. The processing to be applied to the program information is referred to as “channel adjustment”.

The following two methods are available for the channel adjustment.

(a1) The channel adjustment is made before display of information of the another user, related to the viewing reservation and reservation information. In this case, on the images of FIGS. 21 and 22, a broadcast station name and air date/time that have already been adjusted are displayed.

(a2) On the images of FIGS. 21 and 22, information of the another user, related to the viewing reservation and reservation information before the channel adjustment are displayed. Then, after operation of the import of the reservation information, the channel adjustment is made, and adjusted information are added to the calendar.

As described above, in the present apparatus, the present user can associate information of the another user, related to the viewing reservation and reservation information with his or her (present user's) calendar.

There are the following modes where the information is associated with the calendar:

(b1) a mode where the information in an apparatus that the present user him or herself uses is associated with the calendar;

(b2) a mode where the information in another apparatus in the present user's home is associated with the calendar managed in his or her apparatus; and

(b3) a mode where the information in the cloud service server is associated with the calendar managed in the present user's apparatus.

Here, the priority between the above modes is considered. In this association processing, the mode (b1) where the information in an apparatus that the present user him or herself uses is associated with the calendar has the highest priority in the mode (1) to (3). In the apparatus, information of the recording reservation, viewing reservation, recording history, and viewing history are managed by family members on an individual basis. Moreover, whether the managed information is made public or kept private can be set on an individual basis. Alternatively, the managed information can be managed as public information of all family members. This is because the management module manages the data of the recording reservation, recording history, viewing reservation, and viewing history by the login identifier for family use and individual use. When the information in an apparatus that the present user him or herself uses is associated with the calendar, the above-described channel adjustment need not be performed.

The second highest priority in the mode (1) to (3) is the mode (b2) where the information in another apparatus in the present user's home is associated with the calendar managed in his or her apparatus. Also in this case, the above-described channel adjustment need not be performed.

The lowest priority in the mode (1) to (3) is the mode (b3) where the information in the cloud service server is associated with the calendar managed in the present user's apparatus. This mode is effective for a case where the present user erroneously delete the viewing reservation information (or recording reservation information) in his or her apparatus. Particularly, in a case where the user deletes the viewing reservation information (or recording reservation information) that has been imported from an external apparatus, it is impossible to recover the viewing reservation information (or recording reservation information) in his or her apparatus.

In such a case, there is a possibility that the corresponding information is stored in the cloud service server, and it is convenient to acquire the viewing reservation information (or recording reservation information) from the cloud service server.

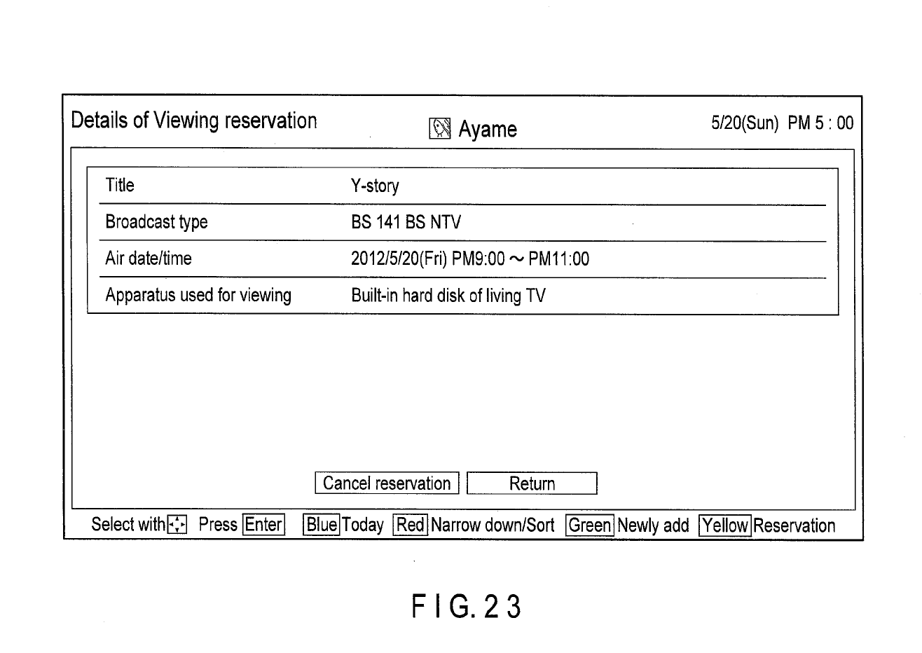

FIG. 23 illustrates an example of an image to be displayed when the viewing reservation (or recording reservation) is canceled. The image of FIG. 23 is a detailed view of the image of FIG. 13C shifted from the image of FIG. 13B. There are displayed, on the image of FIG. 23, detailed information on a program for which viewing is reserved and a “reservation cancel” button. When there is a need to cancel the viewing reservation for the program for which viewing is reserved, the “reservation cancel” button is selected using the cursor, followed by pressing of the enter button, whereby the viewing reservation for the program is canceled. The same method can be applied for the recording reservation so as to cancel the reservation.

In the modes described using (b1), (b2), and (b3), the viewing reservation information (or recording reservation information) can be shifted from the preview state.

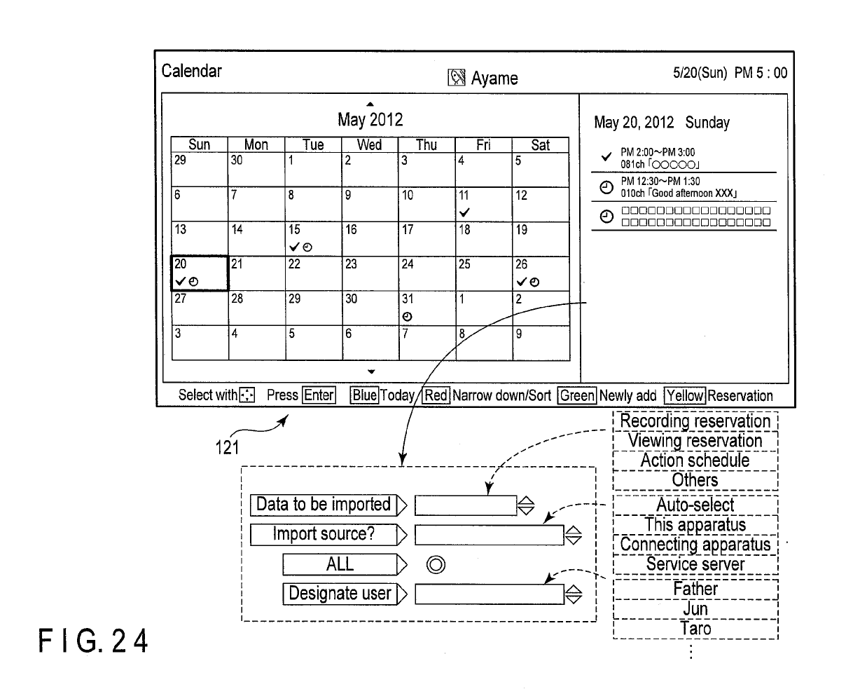

For example, as illustrated in FIG. 24, when a “newly add” button 121 is selected, followed by pressing of the enter button, a setting image of the association processing appears. In the example of FIG. 24, import of the reservation information describing the event (recording reservation or viewing reservation) on May 20 of a public calendar of the another user is performed. In this setting image, there appears a button for determining an import destination (“recording reservation”, “viewing reservation”, “action schedule”, or “others”) of the data to be imported.

It is possible to designate one of the import destinations: “recording reservation”, “viewing reservation”, “action schedule”, and “others” by the cursor-up/cursor-down key.

Moreover, there appears a button for designating an import source of the reservation data. It is possible to designate one of import sources: “auto-select”, “this apparatus”, “connecting apparatus”, and “service server” by the cursor-up/cursor-down key. When the “auto-select” is designated in a state where the viewing reservation is set, modes of the (b1) . . . “this apparatus”, (b2) . . . “connecting apparatus”, and (b3) . . . “service server” described above are sequentially performed. After completion of the import from the “this apparatus”, a message saying <import from “this apparatus” is completed. Continue?> appears. Further, after completion of the import from the “connecting apparatus”, a message saying <import from “connecting apparatus” is completed. Continue?> appears. The user can instruct “continue” by operating the enter button and can instruct “end” by operating an end button. After completion of the import from the “service server”, a message saying <import of reservation information is end> appears.

Moreover, with regard to the selected “day”, whether the reservation information of all the users or only designated users are imported can be set. To this end, a button for designating all the users and a button for designating each user are prepared.

As described above, according to the present apparatus, additional information can be added to the calendar so as to make the calendar be a multifunctional calendar. The information calendar can be upgraded. If there is an overlap between additional information to be added to the calendar, the highest priority is given to the additional information of the calendar of the present user who is operating the television apparatus. The additional information having the second highest priority is additional information of the calendar of the another user that is stored in the television apparatus. The additional information having the third priority is additional information from the cloud service server.

In the present apparatus, the user can set “private” or “public” for, for example, the entire calendar. Thus, the reservation information of a “private” calendar of a given user cannot be imported by the another user. The “private” or “public” may be set for each reservation information. In a case where the calendar is made public, a scope of disclosure may be set.

For example, on the image of FIG. 22, a button for setting “public” or “private” is provided in an area 119. When the “public” button is marked, the corresponding reservation information is made public, and when the “private” button is marked, the corresponding reservation information is kept private. In FIG. 24, whether the reservation information to be imported is made public or kept private can be selected. Moreover, there may be prepared a setting image for selection of whether the additional information included in the entire calendar is made public or kept private, a setting image for selection of whether the additional information included in a part of the calendar is made public or kept private, a setting image for selection of whether the additional information is made public or kept private according to classification thereof. Moreover, a setting image for setting a scope of disclosure may be prepared. For example, disclosure of the reservation information may be limited to apparatuses connected to a home LAN or to designated apparatuses.

In the control for “public”/“private” setting, the following rule is set. That is, “private” setting cannot be made for common data (recording reservation data, viewing reservation data, calendar, etc.) of an apparatus shared by all family members, serving as a common domain to which all family members can login.

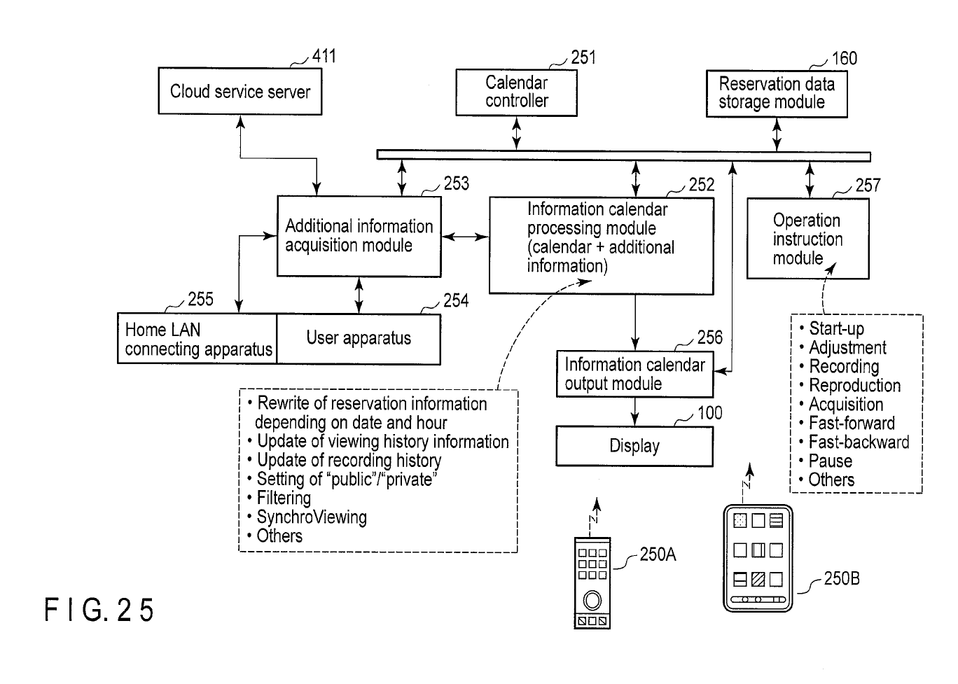

FIG. 25 illustrates a configuration of a block that processes the calendar to generate information calendar. The block of FIG. 25 corresponds to a block involving the calendar processing illustrated in the television apparatus of FIGS. 5 and 12.

The calendar is processed under control of a calendar controller 251. An information calendar processing module 252 can import the viewing reservation information and recording reservation information from an additional information acquisition module 253. A calendar of a logged-in user is set in the information calendar processing module 252. The additional information acquisition module 253 can acquire a calendar of another user in the present apparatus, a calendar of another apparatus connected to the present apparatus over the home LAN, and a calendar stored in the cloud service server 411. The information calendar processing module 252 can perform combining processing (above-described information import processing for recording reservation and viewing reservation) of combining the calendar of the logged-in user and information of another calendar.

The information calendar set in the information calendar processing module 252 can be displayed on a display 100 through an information calendar output module 256. As described above, the information calendar can be displayed in various forms.

The additional information added to the information calendar is grasped by the calendar controller 251. Thus, the calendar controller 251 controls an operation instruction module 257 so as to execute the switching of the display mode, scroll, import of the reservation information, and the like based on user's operation with respect to a remote controller 250A or a mobile terminal 250B. Moreover, when a start time of the recording reservation or viewing reservation is reached, the calendar controller 251 sends a corresponding command to the operation instruction module 257. Based on the command, the operation instruction module 257 can start operation of the television apparatus, such as recording and reproduction. Moreover, when a given event item is selected, followed by pressing of the enter button, the calendar controller 251 can start operation for displaying details of the corresponding event item.

The recording reservation data and viewing reservation data are stored in a reservation data storage module 160 as the additional information. The reservation data storage module can further store various data (event, action schedule, etc.) to be associated with the calendar. The television apparatus has the recording reservation function and viewing reservation function and generates the recording reservation data and viewing reservation data. The recording reservation data and viewing reservation data are managed on a per-user basis or per-family basis. When the recording reservation is made, a program list created from electronic program guide (EPG) data is used. For the viewing reservation, a past recording history program list is created from recording program information recorded in the HDD, and the viewing reservation is made based on the recording history program list. The information calendar processor 252 uses the reservation data stored in the reservation data storage module 160 to generate the information calendar of the logged-in user.

The words “processor”, “unit” and “module” in the above description may be represented or replaced with “means”, “block”, and “section”.

A main block of FIG. 25 includes: a storage module (for example, reservation data storage module) for storing first additional information to be associated with a first calendar (calendar of a logged-in user); an information acquisition module (for example, additional information acquisition module 253) that can acquire, from another electronic apparatus, second additional information to be associated with a second calendar (calendar of a family member or a friend); an output module (for example, information calendar output module 256, information calendar processing module 252) that associates the first and second additional information with the first calendar and outputs the resultant first calendar; and a controller (calendar controller 251, operation instruction module 257) that executes processing for the second additional information of the first calendar based on the user's operation.

FIG. 25 illustrates a block configuration. In the system illustrated in FIGS. 5 and 12, the block configuration of FIG. 25 can be constructed as software (computer program) for realizing the operation thereof. Moreover, the shifting and change of various image described in the present specification can be realized by display the software (computer program) stored in a recording medium (semiconductor memory, magnetic disk, optical disk, etc.). A method for the user to make the operation instruction is not limited to the method described in the present specification, but various methods can be adopted.

In one aspect, the embodiment described above is also provided as a method. That is, a calendar information processing method acquires the additional information to be associated with the calendar and generates the information calendar by adding the additional information to the calendar. The method outputs the information calendar for display and instructs operation to be performed based on the additional information of the information calendar.

In one aspect, a computer program for controlling a computer is included in the scope of the embodiment. That is, the computer program includes a command for acquiring the additional information to be associated with the calendar, a command for generating the information calendar obtained by adding the additional information to the calendar, a command for outputting the information calendar for display, and a command for instructing operation to be performed based on the additional information of the information calendar. Moreover, an information storage medium storing the computer program for controlling a computer is included in the scope of the embodiment.

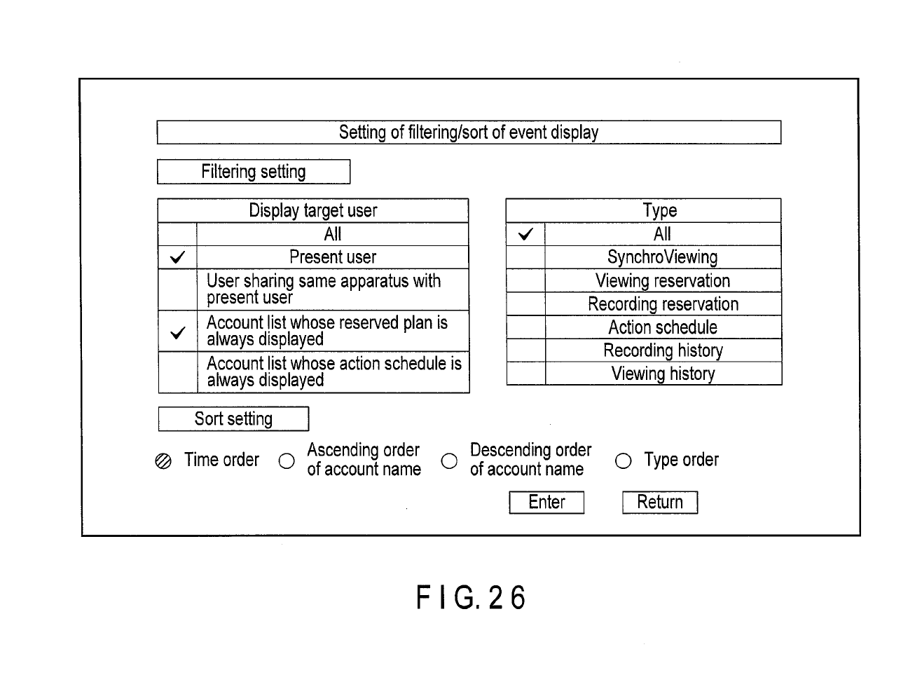

FIG. 26 illustrates an example of an image to be displayed for filtering setting. As described above, the present apparatus can import many event information and thus can refer to may event information. However, when there exist many events, conformation thereof takes a lot of trouble. Thus, in the present apparatus, filtering of the events can be performed so as to change a display order thereof.

For example, by operating a red key of the remote controller, it is possible to shift from the screens illustrated in FIGS. 23 and 24 to the image of FIG. 26. As seen in the image of FIG. 26, a target user (display target user) to be displayed in the event item can be set. In the above description (FIGS. 13A and 13B), the event that is registered in the calendar is displayed. However, in the present apparatus, in a case where there exist the “public calendar” and “public” event, the display target user is set, whereby the public events can be displayed as illustrated in FIG. 13B.

In the example of FIG. 26, a setting image for setting the display target user is disposed in a left area. In this example, a check box of the present user him or herself and a check box of a user who allows his or her reserved plan (viewing reservation, recording reservation, etc.) to be always displayed have been checked. A list of the display target user further includes a user sharing the same apparatus with the present user, a user who allows his or her action schedule to be always displayed, and the like. Moreover, in the example of FIG. 26, a setting image for setting the event type is disposed in a right area. In this example, a check box of “All” (display all events) has been checked. A list of the event type further includes SynchroViewing, viewing reservation, recording reservation, action schedule, recording history, viewing history, and the like.

Moreover, in a lower region of the image of FIG. 26, there is provided a button for selecting any one of time order, ascending order of account name, descending order of account name, type order when performing sort. In this example, the time order is selected, and thus the events are sorted so as to be arranged in the time order. When the enter button is pressed, sort is executed according to the set filter. This allows items of the events that have been narrowed down in a user-preferred manner to be arranged in a user-preferred order.

The present apparatus has a SynchroViewing function. With this SynchroViewing function, when a user (owner) wants to view the same program simultaneously with a plurality of friends or relatives in the distance, he or she can invite the friends or relatives.

Examples of a program or content to be viewed simultaneously include an on-air program, recorded program, video on-demand, and the like. However, the on-air program has a constraint that the air time thereof needs to be the same in all the resident areas of the friends or relatives.

As described above, in the present system, the user can communicate with the plurality of friends or relatives in the distance. Moreover, as illustrated in FIG. 4, the user can confirm a log-in state of the friend and the like.

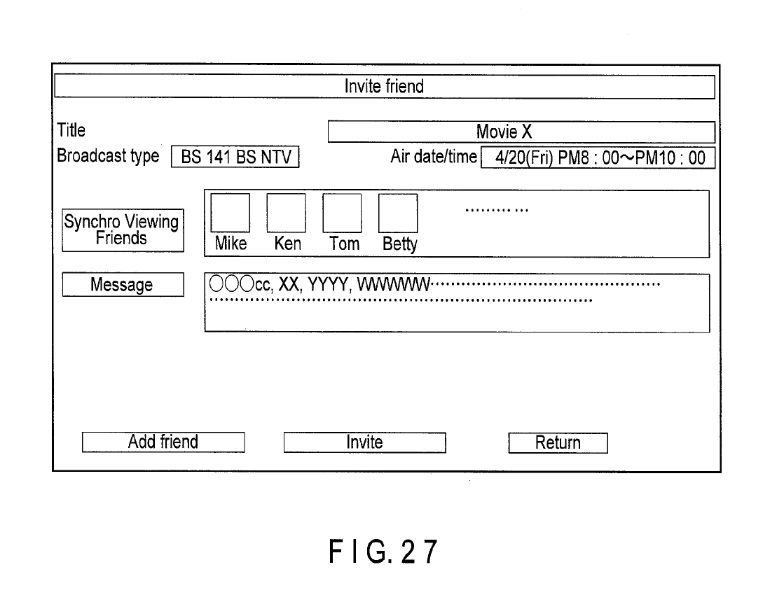

FIG. 27 illustrates an example of an image used when the user invites his or her friend to the SynchroViewing. The image of FIG. 27 can be displayed by operating a SynchroViewing key of the remote controller. Alternatively, a SynchroViewing setting button may be provided on, for example, an event details screen (for example, FIG. 13, FIG. 14). In this case, by selecting the SynchroViewing setting button and pressing the enter key, the image of FIG. 27 can be displayed.

As illustrated in FIG. 27, in a upper area of the image, “invite friend” as a title of the image itself is displayed. Also, there are title, type of broadcast, and air date/time of the “program” which the owner (user) wants to view simultaneously with his or her friends.

In a lower area of the image, a “add friend” button for adding a new friend, an “invite” button, and a “return” button are displayed. When the “add friend” button is selected using the cursor, followed by pressing of the enter key, a face image (or icon or avatar) and a name of a first friend registered in the management unit are displayed. When the enter key is pressed in this state, the face image and name are registered and the first friend is set as a participant. When a “next key” is operated in a state where the face image and name of the first friend is displayed, a face image and a name of a second friend appear. When the enter key is pressed in this state, the face image and name of the second friend are registered and the second friend is set as a participant. When the cursor is moved to “message” in a state where the participants are set, a message can be input. As described above, the friend is selected from the account list registered in the management unit.

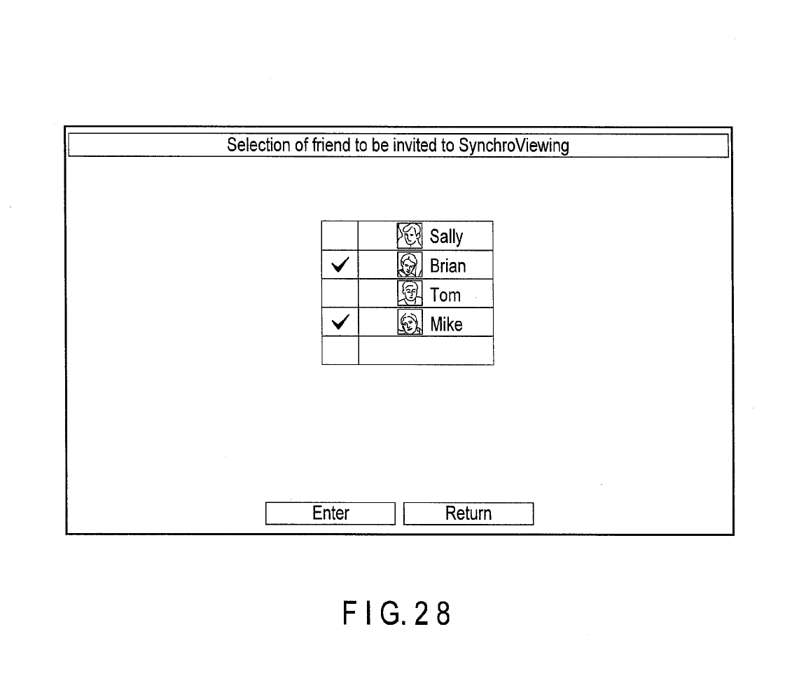

FIG. 28 illustrates another embodiment used when designating the friend to be invited to the SynchroViewing. For example, when the “add friend” button of FIG. 27 is selected, followed by pressing of the enter button, an image of FIG. 28 may appear. On the image of FIG. 28, a face image and a name of the friends previously registered in the management unit are displayed. The owner can designate the friend to be invited to the SynchroViewing by checking a check box corresponding to a desired friend. When the owner operates the return button, the image returns to the image of FIG. 17, where he or she can input a message.

After inputting the message, the user (owner) moves the cursor to the “invite” button and presses the enter button. Then, the message is transmitted to respective friends. The invited friend opens his or her mail-box, opens the message, and transmits a return message. The return message in this case includes answer of “approval” or “pending” in the head thereof or in a specific position thereof. The “approval” means “to participate in the SynchroViewing”, and “pending” means “whether to participate in or not the SynchroViewing is unclear”. In a television apparatus of the invited friend, viewing reservation is automatically made with respect to a SynchroViewing program, or the current image shifts to an image for making the viewing reservation. At this time, the “channel adjustment” described above is executed according to need.

In the owner's television apparatus, the face images (or icons) of all the invited friends can be seen in area 104 described in, for example, FIG. 4. On the other hand, in the television apparatus of the invited friend, the face image (or icon) of only the friend participating in the SynchroViewing can be seen.

In the SynchroViewing, when operation of, for example, fast-forward, pause, or fast-reverse of the recorded program or video on-demand is performed in the owner's television apparatus, the fast-forward, pause, or fast-reverse is executed in a synchronous manner in the television apparatus of the friend participating in the SynchroViewing. This is because, in a SynchroViewing operating state, control information of the owner's television apparatus is transmitted to the television apparatus of the friend participating in the SynchroViewing through the cloud service server.

In the SynchroViewing function, a time shift function is utilized. The time shift function enables all programs of, for example, set six channels for about one to three weeks to be simultaneously recorded in the HDD. The user can refer to the viewing reservation data by operating the television apparatus to select his or her desired program and execute reproduction of the selected program. Utilizing this time shift function enables the SynchroViewing to be achieved with many participants and increases the number of programs to be subjected to SynchroViewing.

For the SynchroViewing of the on-air program, the owner may arbitrarily select the participant, and invited friend may deny the participation. This is because the on-air program may differ in air time from one region to another.

As described in FIG. 12, the television apparatus has a near-field communication function and can thus communicate with a mobile terminal (for example, tablet).

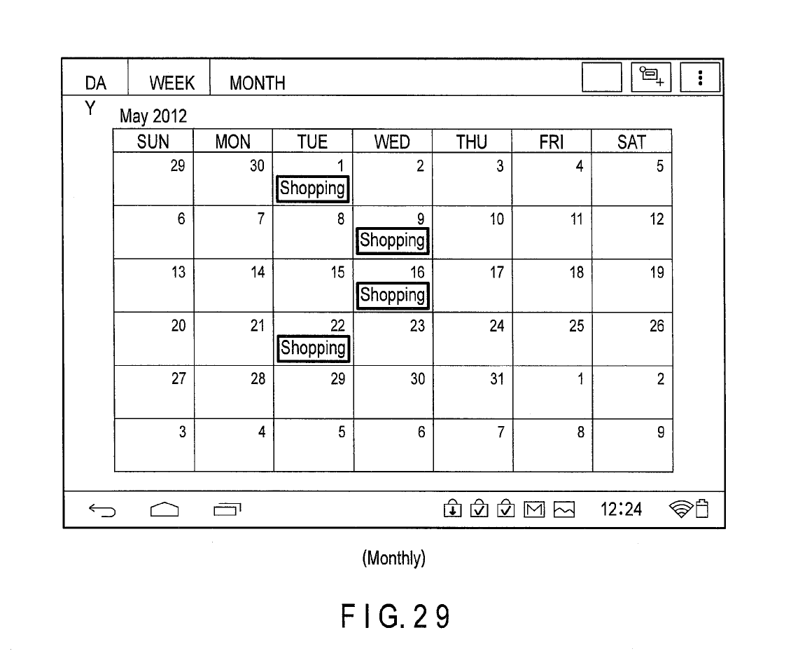

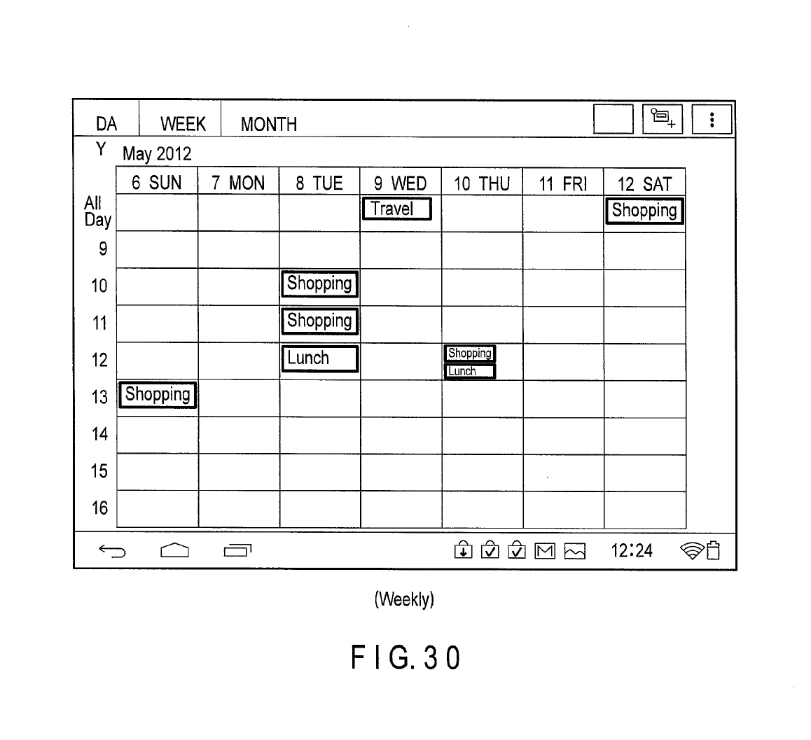

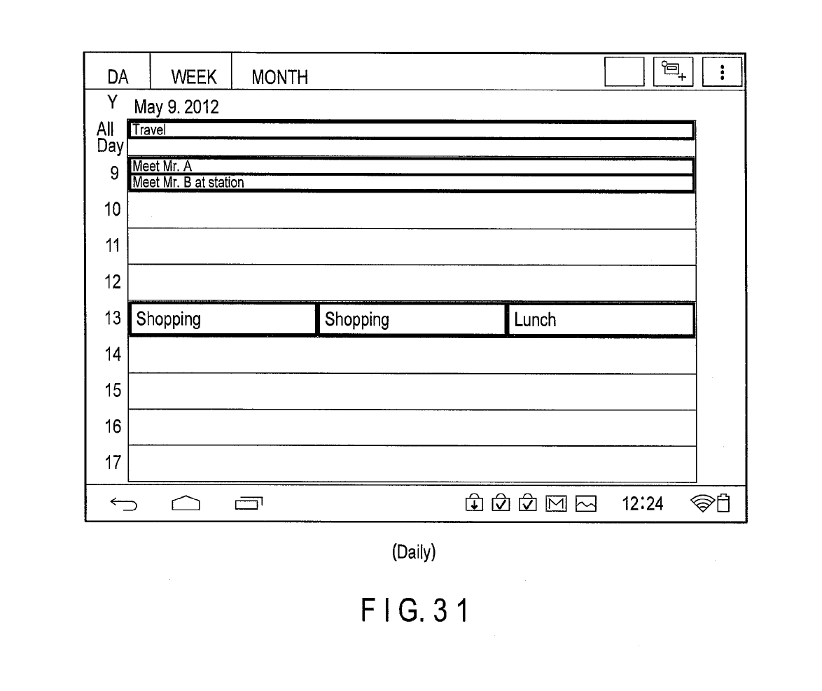

Thus, the calendar view, month view, and list view can be obtained on a tablet screen. A display screen of the tablet has high resolution. Thus, images illustrated in FIGS. 29, 30 and 31 can be obtained. FIG. 29 illustrates an example of a monthly calendar view displayed on the tablet screen. FIG. 30 illustrates an example of a weekly calendar view displayed on the tablet screen. FIG. 31 illustrates an example of a daily calendar view displayed on the tablet screen.

As can be seen from the image examples, on the display screen of the television apparatus, icons of the events such as recording reservation, viewing reservation, and action schedule are displayed in the monthly calendar. On the other hand, on the tablet screen, the event name is displayed. The present apparatus is not limited to the embodiment described above.

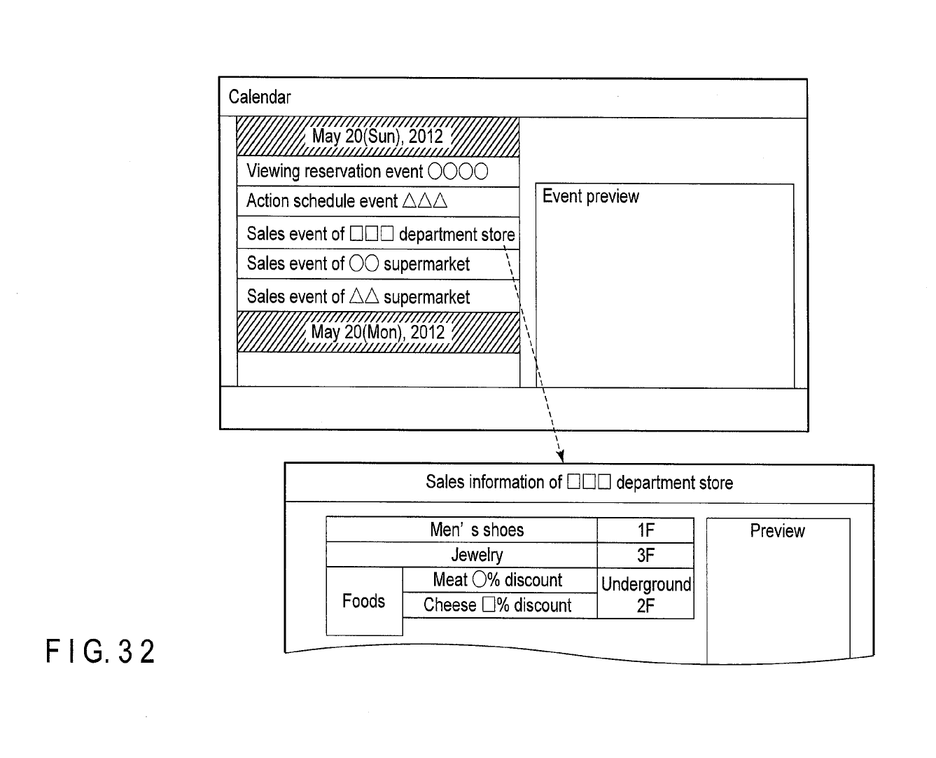

FIG. 32 illustrates another example of an image obtained by an information calendar processing system of the present apparatus. In this example, an area of, for example, May 20 is selected in the monthly calendar, and various events on May 20 are displayed. Assume that department sales event is selected using the cursor, followed by pressing of the enter key. Then, details of the department sales are displayed. The user can cancel the action schedule (shopping, etc.) on that day, newly add an event to that day, or change his or her schedule on that day. Although the events concerning a supermarket and a department are displayed, an event schedule of a theater, a movie schedule of a movie theater, public information of a famous star, and the like can be imported.

In the present apparatus, when the recording reservation is executed based on the recording reservation information, the recording reservation information is converted into the recording history information for storage. The viewing reservation information is converted into the viewing history information for storage after completion of the viewing on a viewing reserved date/time. The above information processing is executed in the information calendar processing module illustrated in FIG. 25.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An method comprising:
transmitting, to a first apparatus, first scene information regarding a first scene of a plurality of scenes included in a first content;
receiving first information indicating that the first scene is not stored in the first apparatus; and
prohibiting deletion of the first scene based on the first information.

2. The method of claim 1, further comprising:
retaining, based on the first information, the first scene to be stored after elapse of a store time of the first content.

3. The method of claim 2, further comprising:
receiving second information indicating that the first scene is stored in the first apparatus; and
deleting, based on the second information, the first scene after elapse of the store time.

4. The method of claim 3, wherein the first scene information is used for recommending viewing of the first scene to a user of the first apparatus.

5. The method of claim 1, wherein the first information comprises designation information designating a storage, and the method further comprising:
storing the first scene in the storage designated by the designation information.

6. The method of claim 1, wherein the first information comprises destination information designating a format, and the method further comprising:
storing the first scene in the format designated by the designation information.

7. The method of claim 1, wherein the first information comprises destination information designating an image quality, and the method further comprising:
storing the first scene in the image quality designated by the designation information.

8. The method of claim 1, further comprising:
receiving format information of the first apparatus; and
storing the first scene in a format based on the format information.

9. The method of claim 3, wherein the prohibiting comprises prohibiting deletion of the first scene until one of the first and second information is received.

10. The method of claim 3, wherein
the transmitting comprises transmitting the first scene information to a plurality of apparatuses including the first apparatus,
the retaining comprises retaining, based on the first information received from the apparatuses, the first scene after elapse of the store time, and
the deleting comprises deleting, based on the second information received from the apparatuses, the first scene after elapse of the store time.

11. The method of claim 1, further comprising:
receiving second scene information regarding a second scene from a second apparatus; and
transmitting, based on an absence of the second scene, third information indicating that the second scene is not stored or fourth information instructing retention of the second scene after elapse of a store time.

12. The method of claim 11, further comprising:
transmitting, based on a presence of the second scene, fifth information indicating that the second scene is stored or sixth information instructing deletion of the second scene after elapse of the store time to the second apparatus.

13. The method of claim 11, further comprising:
outputting, based on the absence of the second scene, confirmation information confirming whether to request retention of the second scene after elapse of the store time; and
transmitting, based on a retention instruction in response to the confirmation information, the third information or fourth information to the second apparatus.

14. An apparatus comprising:
a communication module configured to:
transmit, to a first apparatus, first scene information regarding a first scene of a plurality of scenes included in a first content; and
receive first information indicating that the first scene is not stored in the first apparatus; and
a controller configured to prohibit deletion of the first scene based on the first information.

15. The apparatus of claim 14, wherein the controller is configured to retain, based on the first information, the first scene to be stored after elapse of a store time of the first content.

16. The apparatus of claim 15, wherein
the communication module is configured to receive second information indicating that the first scene is stored in the first apparatus, and
the controller is configured to delete, based on the second information, the first scene after elapse of the store time.

17. The apparatus of claim 14, wherein the first scene information is used for recommending viewing of the first scene to a user of the first apparatus.

18. A non-transitory, computer-readable storage medium having stored thereon a computer program which is executable by a computer, the computer program controls the computer to execute function of:
transmitting, to a first apparatus, first scene information regarding a first scene of a plurality of scenes included in a first content;
receiving first information indicating that the first scene is not stored in the first apparatus; and
prohibiting deletion of the first scene based on the first information.

19. The medium of claim 18, the computer program controls the computer to further execute function of:
retaining, based on the first information, the first scene to be stored after elapse of the a store time of the first content.

20. The medium of claim 19, the computer program controls the computer to further execute function of:
receiving second information indicating that the first scene is stored in the first apparatus; and
deleting, based on the second information, the first scene after elapse of the store time.
